(19) United States
(12) Patent Application Publication
(10) Pub. No.: US 2012/0144315 A1
(43) Pub. Date: Jun. 7, 2012

(54) AD-HOC ELECTRONIC FILE ATTRIBUTE DEFINITION

(75) Inventors: Mark Rosenberger, Calgary (CA); Ganesh Murdeshwar, Calgary (CA)

(73) Assignee: Tagle Information Technology Inc.

(21) Appl. No.: 13/371,276

(22) Filed: Feb. 10, 2012

Related U.S. Application Data
(63) Continuation-in-part of application No. 12/707,205, filed on Feb. 17, 2010.
(60) Provisional application No. 61/153,252, filed on Feb. 17, 2009.

(51) Int. Cl. G06F 3/048; G06F 17/30

(52) U.S. Cl. 715/748; 707/828; 707/E17.01

(57) ABSTRACT

Embodiments disclosed herein generally relate to systems and methods for classifying, sorting, storing, managing, tagging, searching, organizing, and/or performing actions on files, folders and other electronic information using one or more data processing systems.

### CROSS-REFERENCE

This application is a continuation-in-part of U.S. patent application Ser. No. 12/707,205, titled “Methods and Systems for Management of Data” and filed on Feb. 17, 2010, which claims priority from the U.S. provisional patent application Ser. No. 61/153,252, titled “Methods and Systems for Management of Data” and filed on Feb. 17, 2009. Each of the Ser. No. 12/707,205 and 61/153,252 applications is hereby incorporated by reference in its entirety.

### FIELD OF THE INVENTION

Embodiments disclosed herein generally relate to systems and methods for classifying, sorting, storing, managing, tagging, searching, organizing, and/or performing actions on files, folders and other electronic information using one or more data processing systems.

### BACKGROUND OF THE INVENTION

A problem exists within the field of searching, organizing, and/or performing actions on electronic information, which includes the area of personal information management (“PIM”): this space is fragmented. Not only is it split up into physical locations such as mobile devices (e.g., phones and PDA's), computer hard drives, Local Area Networks, and across the World Wide Web, but it is also split up into virtual locations because individual software applications generally use separate folder structures and/or locations. For example, email may be filed separately from files, browser bookmark folders may not be shared with webmail folders, and so on.

If a person wants to organize information by a project number for example, that project folder must be duplicated within each relevant application and then viewed in each such application separately. The more applications used, the more fragmented information becomes, and the more difficult it is to manage the information. To solve this problem, some software vendors have attempted to create a variety of unified data structures (each a “UDS”) that can be shared between applications of all kinds.

Many software vendors have attempted to create UDSs, but they generally fail to address many key usability issues, including:
Such UDSs create a separate, physical data location. As a result, information is brought together into a central data repository, which leads to duplication and problems with version control. Such UDSs may also require additional storage capacity.
Such UDSs create a separate graphical user interface (“GUI” or “UI”) within a particular application. In order to use the UDS, the information is organized in another UI. If working in an email client for example, one would view the email messages in a different application window in order to organize and navigate the messages within the UDS.
Such UDSs may use folders. Folders are a rigid way to structure information and, once created, lock the user into a single organizational perspective until modified. In a schema involving multiple projects and multiple cities, for example, to organize projects by city, a user would create a city\project folder where city is the parent folder of projects. If the user then wants to see cities by project, they would need to reverse the parent-child relationship to project\city, which is generally not possible.
In such UDSs, categories may be duplicated. A general problem with taxonomy is contextual duplication. For example, the terms “Expense” and “Expenses” almost certainly define the same context and most UDSs will not provide any preventative measures for context duplication. This problem is further exacerbated by duplication in nested folder trees where the desired category may be duplicated many times depending on the nested order. An example of path duplication for the term “expenses” would be city\project\expenses and project\city\expenses.
Such UDSs requires “top down” navigation. In order to access the organized data, a user would first find the parent category and then open it to view the contents. If the category name is forgotten, the contents will not be found unless a search mechanism is used, which defeats a purpose of using categories in the first place.
In such UDSs, the organizational process is not automated in any way. In Microsoft Windows for example, a user would manually place files in folders. Making the decision of “where to file” may require significant decision-making thought processes, which could become a distraction from accomplishing the task at hand. Similar decision-making effort would be required in creating new folders as well because a meaningful category name must be created in order to remember how to find it later on.
Such UDSs do not generally perform actions on the information. PIM applications are generally limited to organization only. In many situations, however, it could be beneficial if an action were simultaneously associated with, or otherwise performed in connection with the organization or filing of information, thereby combining two tasks into one to increase user productivity.

As the numbers of data files and folders managed by users on electronic devices increase, the ability to efficiently locate, sort and manage electronic information becomes progressively more challenging. For example, while search engines have been widely deployed to assist with information search and retrieval on the Internet, across data networks and locally within electronic devices, users are still challenged to determine not only where data files and other information may be located, but also to sometimes assess whether data files and other information desired is even present and available at all.

One approach adopted in the industry to further facilitate management of files, folders and information is illustrated in U.S. Pat. No. 7,051,030 titled “Method and System for Managing A Directory with A Template” issued on May 23, 2006, which is hereby incorporated by reference in its entirety. The U.S. Pat. No. 7,051,030 discloses, among others, how a template may be created to provide structure information to users of the directory and to allow an administrator to more easily configure part or all of the directory.

Another approach adopted in the industry to further facilitate management of files, folders and information is illustrated in U.S. patent application Ser. No. 11/1053,173 with publication number US2005/0192983, titled “Structured Data Storage Method, Structured Data Storage Apparatus, and Retrieval Method,” published on Sep. 1, 2005, which is hereby incorporated by reference in its entirety. The Ser. No. 11/1053,173 application discloses, among others, how to extract common hierarchical structures of data items based on frequencies of occurrence of data items.

Another approach adopted in the industry to further facilitate management of files, folders and information is illustrated in U.S. Pat. No. 7,039,873 titled “User-Defined Templates for Automatic Image Naming” issued on May 2, 2006, which is hereby incorporated by reference in its entirety. The U.S. Pat. No. 7,039,873 discloses, among others, a method for automatically generating names for files uploaded from a computer to a server based on a file-naming template.

Another approach adopted in the industry to further facilitate management of files, folders and information is illustrated in U.S. patent application Ser. No. 09/737,335 with publication number US2002/0078069, titled “Automatic File Name/Attribute Generator for Object Oriented Desktop Shells,” published on Jun. 20, 2002, which is hereby incorporated by reference in its entirety. The Ser. No. 09/737,335 application discloses, among others, how to automatically name a file with a name derived from a file naming property included in a document defining structure.

Another approach adopted in the industry to further facilitate management of files, folders and information is illustrated in U.S. Pat. No. 7,529,773 titled “Idea Service for Automatic File Naming and Storing” issued on May 5, 2009, which is hereby incorporated by reference in its entirety. The U.S. Pat. No. 7,529,773 discloses, among others, a method for automatically naming electronic files by associating metadata with the files, where the metadata may be stored in the header of each file and may automatically designate file names and locations for each file.

Another approach adopted in the industry to further facilitate management of files, folders and information is illustrated in U.S. patent application Ser. No. 11/554,638 with publication number US2007/0179814, titled “System For Processing Data Representing A Deficiency In A Record,” published on Aug. 2, 2007, which is hereby incorporated by reference in its entirety. The Ser. No. 11/554,638 application discloses, among others, a healthcare document processing system that prevents a patient record from being designated complete if certain relevant information is missing.

While such data management approaches can help increase the efficiency and ease of locating and managing information, there is a need for new and additional automatic data processing technology that can increase the intelligence and capabilities of file management systems used to store, manage and process electronic information.

### SUMMARY OF THE INVENTION

In an example embodiment, a system, method, and computer program comprises a set of data processing modules adapted to display a graphical user interface (GUI), where the GUI includes a folder. In one embodiment, the data processing system is further adapted to identify a data item to be added to the folder. In one embodiment, the data processing system is further adapted to identify an electronic template file and/or a characteristic template. In one embodiment, the data processing system is further adapted to automatically define at least a portion of at least one attribute of the data item based on the electronic template file and/or the characteristic template.

In one embodiment, the attribute of the data item is at least one of the following: the name of the data item; the author of the data item; the creation date of the data item; the modification date of the data item; content included in the data item; a tag of the data item; or a characteristic of a tag of the data item.

In one embodiment, the folder is a context-aware folder.

In one embodiment, the electronic template file is a placeholder file.

In one embodiment, the characteristic template corresponds to the electronic template file and/or to the folder.

In one embodiment, the electronic template file is displayed in the GUI using at least one of the following: altering the icon of the template file; superimposing a graphical or textual indicator at least partially over the icon of the template file; displaying a graphical or textual indicator in the proximity of the icon of the template file; displaying a text message in the GUI; sending an email message; sending a text or multimedia message; uploading a message to a server; causing a message to be displayed on a remote website page; modifying a tag of the template file; and/or activating a taglet corresponding to the template file.

In one embodiment, the automatic definition of at least a portion of at least one attribute of the data item includes defining at least a portion of the name of the data item based on the name of the electronic template file.

### INCORPORATION BY REFERENCE

All publications, patents, and patent applications mentioned in this specification, if any, are herein incorporated by reference to the same extent as if each individual publication, patent, or patent application was specifically and individually indicated to be incorporated by reference.

### BRIEF DESCRIPTION OF THE DRAWINGS

The accompanying figures, which together with the detailed description below are incorporated in and form part of the specification, serve to further illustrate various embodiments and to explain various principles and advantages all in accordance with example embodiments of the present invention.

FIG. 1 shows an algorithm for Search as You Type (SAYT) as known in the prior art.

FIG. 2A shows the primary elements and overall layout of the UI of an embodiment of the present invention.

FIG. 2B shows the layout of a sidebar tiled next to corresponding external applications according to an embodiment of the present invention.

FIG. 3A shows a breakdown of select UI components of a sidebar in accordance with an embodiment of the present invention.

FIG. 3B shows a breakdown of select UI components of a results window in accordance with an embodiment of the present invention.

FIG. 4 shows details of select constituent components of a tag in accordance with an embodiment of the present invention.

FIG. 5 shows various states of selections of tags and relationships between a tag and a corresponding data item in accordance with an embodiment of the present invention.

FIG. 6 shows select UI components of a tag FingerTip in accordance with an embodiment of the present invention.

FIG. 7A shows select components and states of a forced tag group, where tags are manually grouped together by the user, in accordance with an embodiment of the present invention.

FIG. 7B shows an example of a “natural” tag group, where tags are automatically grouped together, in accordance with an embodiment of the present invention.

FIG. 8 shows a procedure for tagging data items in a results window in accordance with an embodiment of the present invention.

FIG. 9 shows a process flowchart for using one or more data items to find any related data items in accordance with an embodiment of the present invention.

FIGS. 10A and 10B show selected details of a module that allows grouping of a number of data items into one view to facilitate tagging in accordance with an embodiment of the present invention.

FIG. 11 shows a system for tagging data items from an external application in accordance with an embodiment of the present invention.

FIG. 12 shows a system that includes one or more plug-ins capable of interacting with a set of external applications to help manage data items from the set of external applications, in accordance with an embodiment of the present invention.

FIG. 13A shows a process for detecting and loading taglet plug-ins, in accordance with an embodiment of the present invention.

FIG. 13B shows an implementation whereby tagging a data item with a taglet leads to an action being executed by an application, in accordance with an embodiment of the present invention.

FIG. 14 shows an overview of a system that could accommodate various embodiments of the present invention.

FIG. 15 shows a set of context-aware folders, in accordance with an embodiment.

FIG. 16 shows a flowchart illustrating a process for creating a context-aware folder in accordance with an embodiment.

FIG. 17 shows a flowchart illustrating a process for automatically defining the name or other attributes of a file in accordance with an embodiment.

### DETAILED DESCRIPTION

While the specification concludes with claims defining the features of the invention that are regarded as novel, the invention will be better understood from a consideration of the following description in conjunction with the drawing figures, in which like reference numerals are carried forward.

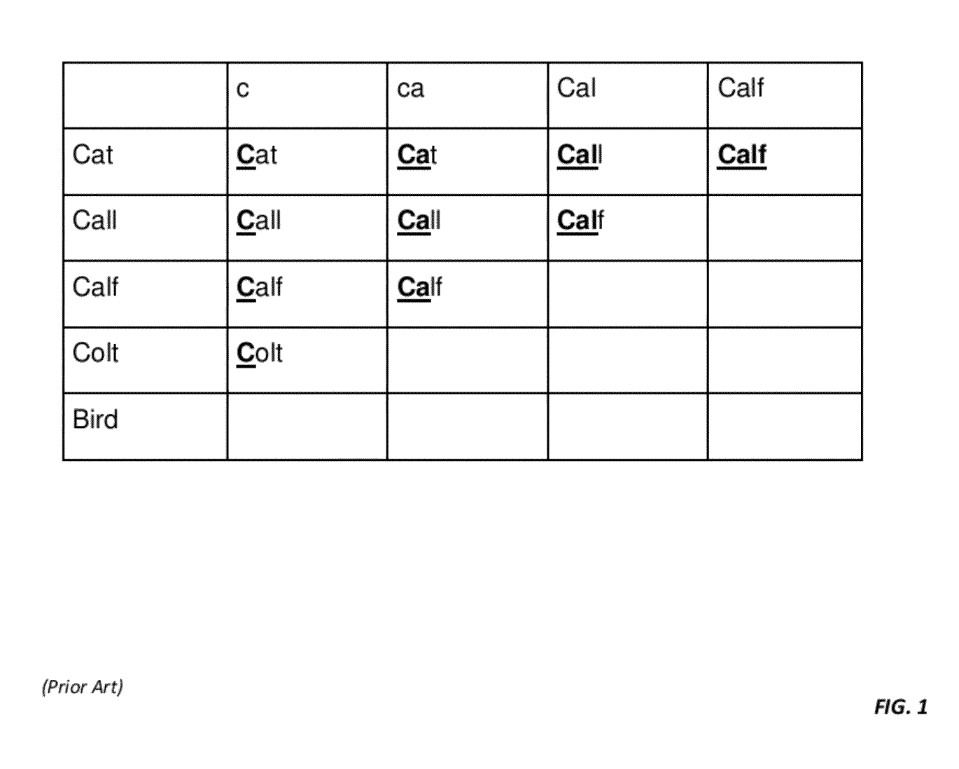

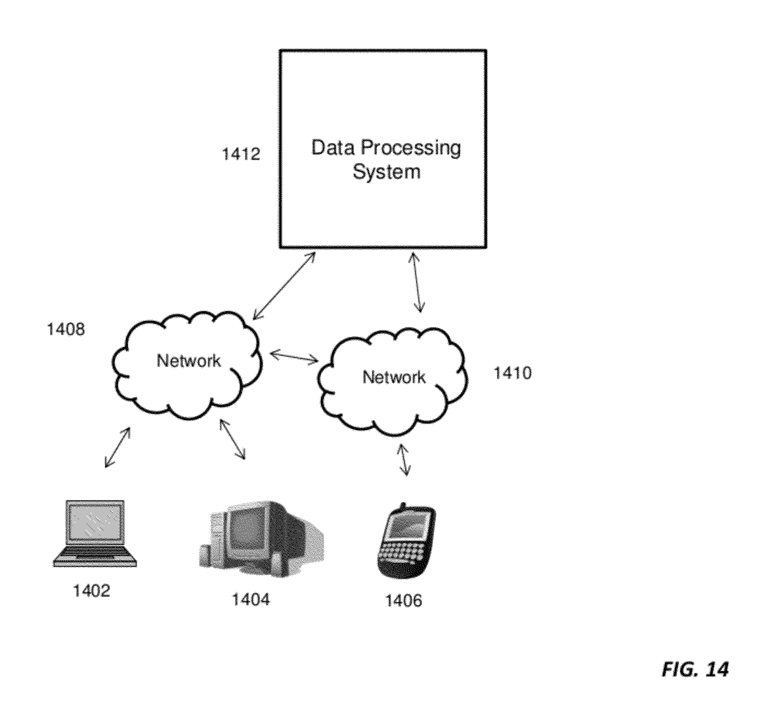

Unless otherwise explicitly stated in this patent, the following terms are intended to have the corresponding meanings set forth below:
“API” is an acronym for application programming interface and means a set of functions, procedures, methods, classes or protocols that that permit interfacing with an application.
“software application” (or “application” when used as a noun to reference software code) means a software application, function, procedure, method, class or other process, whether implemented in programming code, hardware, firmware, or any combination of the foregoing. Software may be in source code, assembly code, object code, or any other format. In various implementations, an application may run on more than one data processing system (e.g., using a distributed data processing model or operating in a computing cloud), or may run on a particular data processing system and may output data through one or more other data processing systems.
“checkbox” means a tag component that can be used to tag data items. A checkbox could be displayed as a square that can be marked with an “X,” with a checkmark, or with any other indication designed to indicate selection. Alternatively, a checkbox may be displayed as any other GUI element that can be selected, marked or otherwise acted upon by a user.
“communication channel” means any line of communication between two data processing systems, including any wireless connection, any wired connection (including serial, parallel, any wired packet based communication protocol (e.g., Ethernet, USB, FireWire, etc.), and any other wireline connection), any optical channel, and any other point-to-point connection capable of transmitting data.
“communication network” or “data network” means any combination of two or more communication channels, including cellular and mobile telephony networks, the Internet, the World Wide Web, and any other information transmission network.
“data item” is the general term for information that is managed or tagged. Data items include an email message, a photograph or other image, a document, a webmail message, a web bookmark, any type of computer file, or in general; an individual piece of information that is part of a larger data set.
“data processing system” means any desktop computer, laptop, netbook, electronic notebook, ultra mobile personal computer (UMPC), client computing device, server computer or server system, cloud computing system, remote computer, mobile telephone, personal digital assistant, personal digital organizer, or any other device, component or system capable of processing electronic data, including any electronic tablet or smartphone. A data processing system may include any of the following: one or more processors (e.g., a CPU, embedded processor, or any other single or multi-core data processing device), one or more internal communication buses, one or more memory media, one or more interfaces for communicating with external devices (e.g., Ethernet, BlueTooth, WiFi, cellular telephony, optical, or any other wired or wireless data communication port), a display (e.g., an integrated LCD display) and/or an interface or connector to an external display, and any other components that may be advantageously used in connection with receiving, processing and/or transmitting information.
“external application” or “remote application” means, with respect to a particular application, an application that is either located on a remote data processing system relative to the particular application, or is located on the same data processing system but runs as a logically separate application, process or thread compared to the particular application. For example, an external application may run on any of the data processing devices (1402), (1404), (1406) or (1412) illustrated in the embodiment of FIG. 14. In various implementations, an external application may run on more than one data processing system (e.g., using a distributed data processing model or operating in a computing cloud), or may run on a particular data processing system and may output data through one or more other data processing systems.
“external data processing system” or “remote data processing system” means, with respect to a particular data processing system, a data processing system that is either physically separate from the particular data processing system, or is physically collocated with the particular data processing system but is acting as a logically separate data processing system (e.g., through hardware or software isolation, through virtualization, etc.).
“include,” “including,” “for example,” “e.g.,” and variations thereof, are not intended to be terms of limitation, but rather are intended to be followed by the words “without limitation.”
“indeterminate” means, with respect to a tag's checkbox, that the state of the tag's checkbox has a “square” within the box or has some other graphical indication other than an unequivocal checked or unchecked state, indicating that some of the selected data items are tagged with it, while some are not.
“MACD” is an acronym for Moving, Adding (creating new), Changing, and/or Deleting (plural: MACDs). “MACD” is a type of action.
to “manage” a data item means to perform an action on a data item.
“MDB” is an acronym for Master DataBase and refers to a memory medium and/or associated software for storing data items, including any applicable systems, methods and procedures that facilitate such storage.
“memory” or “memory medium” or “storage medium” means any chip, device or other structure capable to store electronic information. A memory medium could be based on any magnetic, optical, electrical, mechanical, electromechanical, quantum, or chemical technology, or any other technology or combination of the foregoing that is capable of storing electronic information, and could be centralized, distributed, local, remote, portable, or a combination of the foregoing. Examples of memory media include a magnetic hard disk, a flash memory module, a random access memory (RAM) module, and an optical disk (e.g., DVD, CD).
“module” or “logical module” or “data processing module” means (a) any software application, (b) any portion of any software application that can process data, (c) any data processing system, (d) any component or portion of any data processing system that can process data, and (e) any combination of the foregoing.
to “process” data (including a data item) means receiving, transmitting, caching, displaying, preparing for display, modifying or otherwise executing an instruction in connection with the data (or data item).
“SAYT” is an acronym for Search As You Type, meaning that search results are narrowed down in real time with each key stroke. The table in FIG. 1 outlines how SAYT works. The first row represents the letters that are typed in a search field and the subsequent rows contain the results that would be displayed in the list.
“search field” means a search box in a results window, sidebar or other portion of a GUI that is used to search for data items and tags respectively.
“set” means any group of one, two or more items. “subset” means, with respect to a group of N items, a set of such items consisting of N−1 or less items.
“tag,” as a noun, means a category or key word attribute, or any other identifier, that is assigned to a data item; “tag,” as a verb, is the action of applying a tag (noun) to a data item. Each tag has one or more attributes (tag attributes may also be referred to as tag characteristics). Examples of tag attributes (characteristics) include one or more of the following: name of the data item, location of the data item within a corresponding file structure, name of a folder in which the data item is located, name of a sender of the data item, name of a recipient of the data item, date when the data item was sent, data source of the data item, meta-data corresponding to the data item, or content of the data item.
a “taglet” is a special type of a tag that manages data items, in addition to tagging data items, as further described in this patent.
a “hot key” is a special key or key combination on a computer keyboard to perform an action. An example of a hot key in Microsoft Windows is the use of Alt-Tab to switch between software application windows.
a “plug-in” is a computer program or other module that relays requests between an external application and a local application.
an “action” performed on a data item means to send, store, view, search, share, find, select, connect, tag, modify, or otherwise act directly or indirectly upon, a data item, or any combination of the foregoing.
an “interaction” between a local application and an external application means the transmission of data between the local application and the external application, possibly made via an API.
to “check” a tag means placing a checkmark or other mark indicating selection in a tag's checkbox, indicating that a data item is tagged.
to “close a tag” means to cause its contents to become hidden from direct view or to switch off the contents filter of a tag that is open.
to “de-tag” a data item means to uncheck a tag so that the data item is no longer tagged.
to “interact” with a tag or data item means to select the tag or data item, to hover with a cursor or other pointing tool over the tag or data item, or to otherwise interact with the respective data processing system. Such selection, hovering or interaction could be achieved via a mouse, a keyboard, voice, user intention recognition technology (including optical, facial, or gesture recognition), a stylus, heuristic pointing recognition (e.g., recognizing a set of gestures based on movement of a mobile phone or other mobile device or pointer via motion sensors such as gyroscopes, accelerometers, magnetic sensors, optical sensors, etc.), or any other method that facilitates interaction with the respective data processing system.
to “open a tag” means to manipulate a tag name to cause its contents to become visible or filtered.
to “select” a tag or data item means to make a tag or data item active, possibly indicated by a shaded background, in order to perform an action on it, including management tasks.
to “uncheck” a tag means to cause a tag's checkbox to become blank, severing, at least temporarily, the relationship between the data item and the category, key word attribute, or other identifier assigned to a data item.
two data processing systems, applications or other modules are “logically separate” for as long as they utilize for data processing purposes different virtual machines, different processors, different processor cores, different groups of processor cores, different digital signal processing (DSP) units, or otherwise act as distinct data processing units, applications or respectively modules.
two data processing systems are “physically separate” when they communicate with each other via a communication channel or a communication network.

For clarification, the foregoing definitions and other definitions in this patent, and titles and subtitles, are intended to be descriptive and illustrative with the goal of facilitating comprehension, but are not intended to be limiting with respect to the scope of the invention as recited in the claims. Each of these definitions is intended to also capture additional equivalent items, technologies or terms that would be known to a person of average skill in this art to be equivalent or otherwise interchangeable with the respective item, technology or term so defined.

### Unified Data Structure

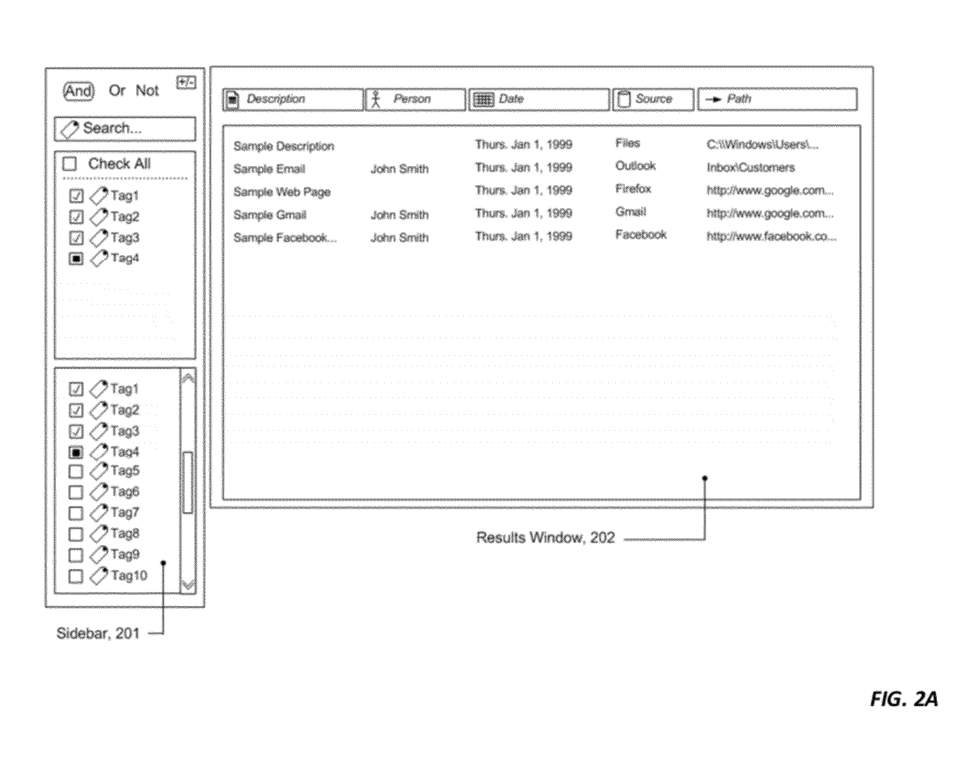

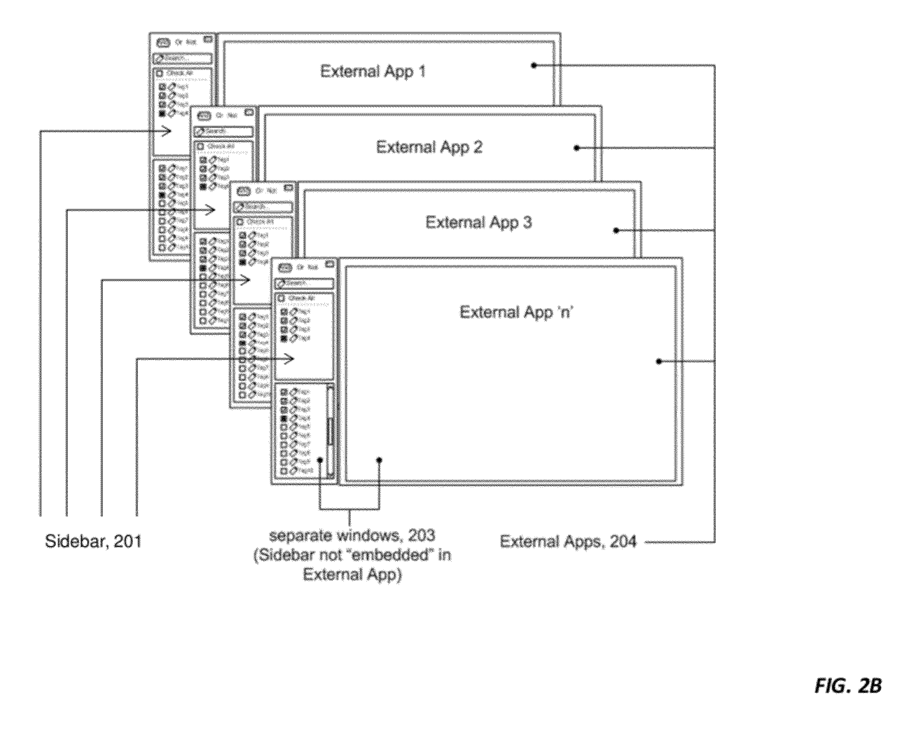

A UI in accordance with an embodiment of the present invention shown in FIG. 2A includes two primary elements: a sidebar (201) and a results window (202). Analogously, in FIG. 2B, a UI in accordance with an embodiment of the present invention includes a sidebar (201) separate from the GUI of external applications 204 (denoted in FIG. 2B as “External App” or “External Apps”). The sidebar serves as the interface for managing tags, and provides a platform for managing data items. The results window serves as the interface for unifying and managing data items stored in one or more external applications 204. In one embodiment, the sidebar (201) and the Results Window (202) of FIG. 2A are used in connection with one or more external applications (204), and manage data items associated with one or more external applications (204). In one embodiment, both the sidebar and results window remain separate (as suggested by label (203) in FIG. 2B) from the UI of external applications (204).

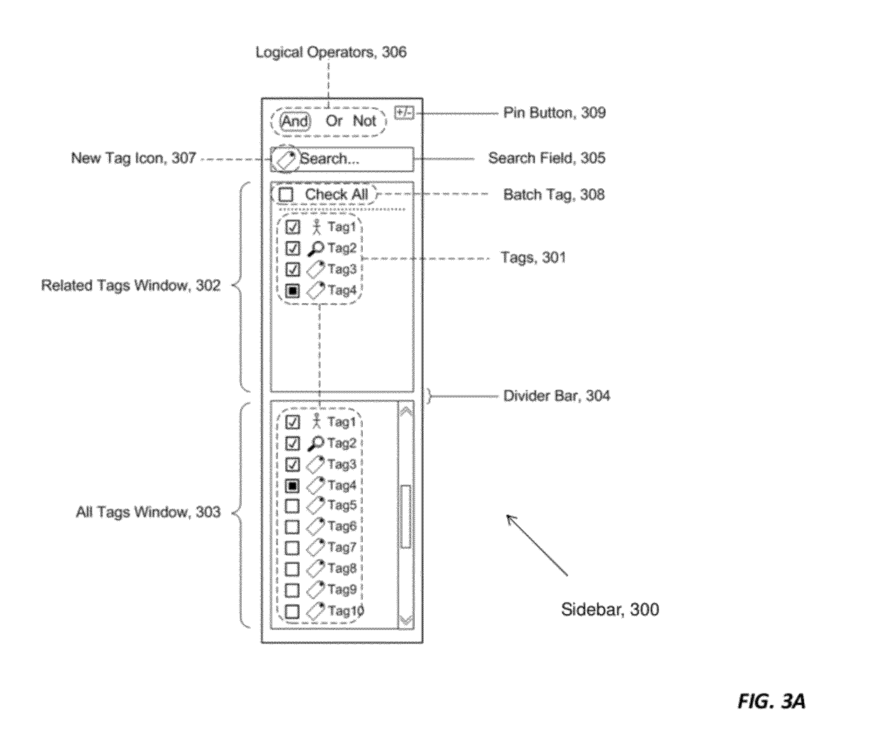

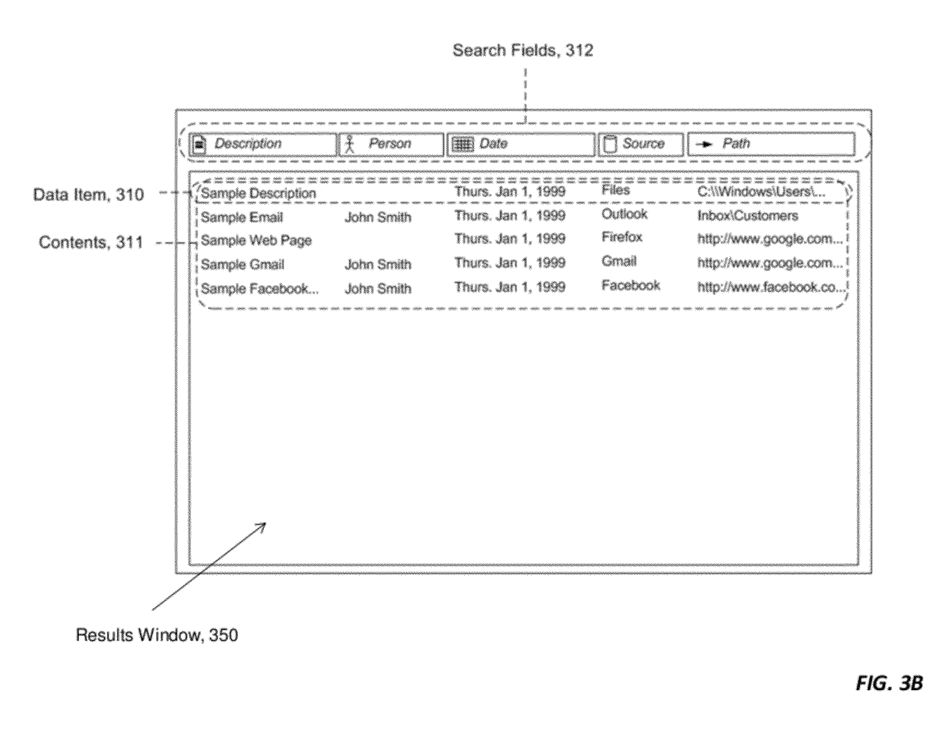

In one embodiment, as shown in FIG. 3A, a sidebar (300) includes three primary elements: the all tags window (303) that displays all tags contained in the MDB or a subset of tags contained in the MDB (e.g., such subset could be preselected based on specific criteria, such as the nature or type of applications, identity of user, etc.), the related tags window (302) that displays tags related to selected data items (301), and one or more search fields (305) for searching tags or groups of tags. In one implementation, the sidebar is invoked using a mouse input or a hot key and moves out from the side of the screen (possibly overlapping other windows or GUI elements already displayed to the user) while it is active and then disappears completely or partially again when inactive. In one embodiment, it can also be “pinned” with the pin button (309) such that it tiles next to other windows without overlapping those windows (or otherwise overlapping those windows only by a predefined amount), thereby keeping it in view until unpinned or otherwise expressly removed from view or obscured by other elements of the GUI.

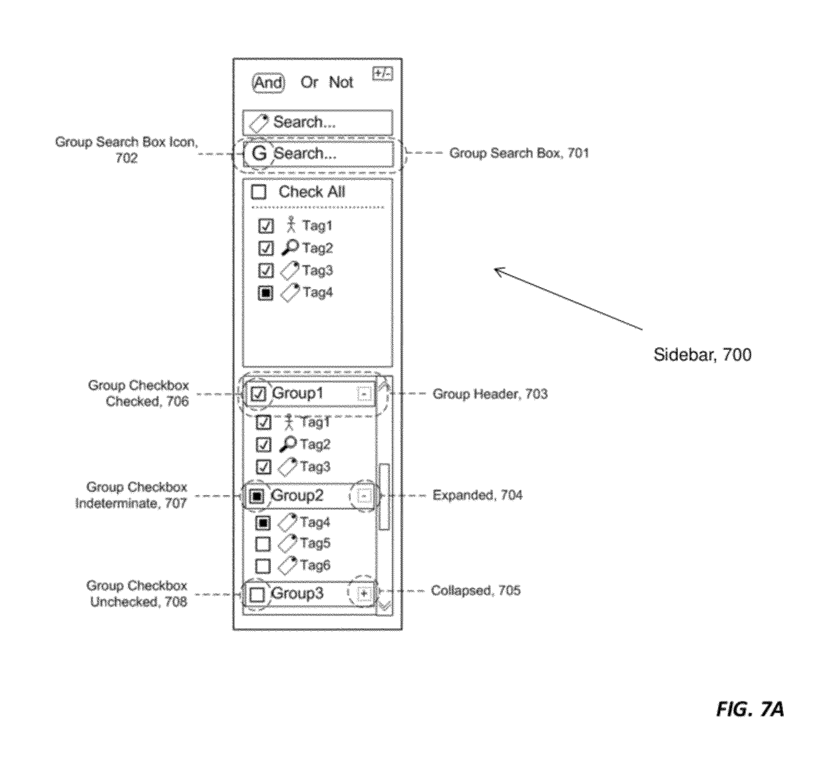

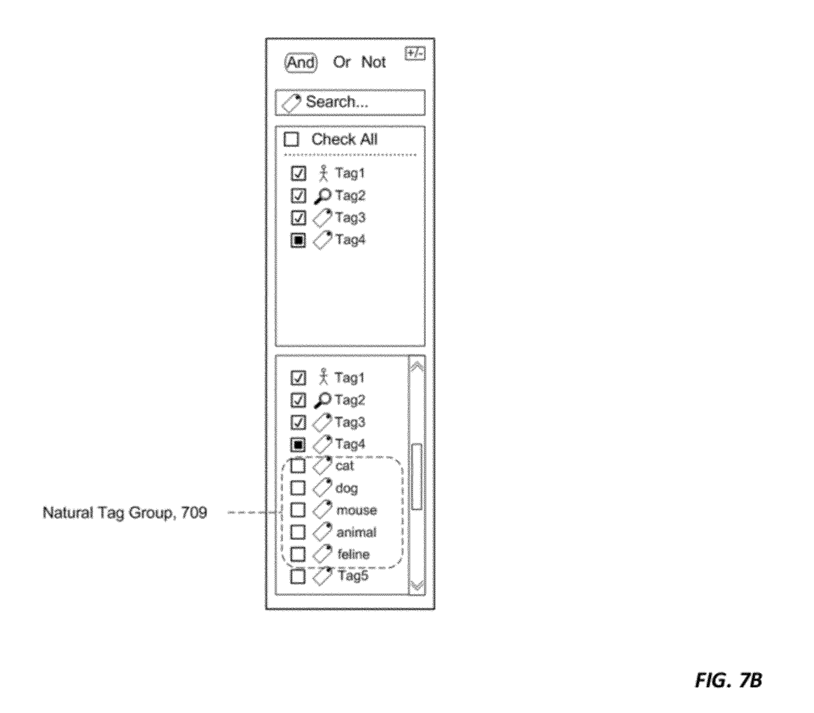

FIG. 3A further shows a batch tag (308) checkbox which, in one embodiment, permits batch tagging of multiple tags. The concept of batch tagging is further described in connection with the embodiment of FIG. 7A.

In one implementation, search field (305) can be used to perform a search for tags or corresponding items. As a tag name is typed, existing tags in the MDB are searched in real time with SAYT results shown in the tag name box. In alternative implementations, various filtering constraints could be further applied to the search to limit the number or scope of tags that are identified through the search (e.g., using logical operators, restrictions on locations of tags or items, etc.).

In accordance with an embodiment of the present invention, new tags or taglets can be created via a new tag icon in a tag search field. Taglets are described in more detail in connection with subsequent embodiments. FIG. 3A shows a new tag icon (307) which, in one embodiment, facilitates the creation of a new tag. The creation of a new taglet would be similar. In one implementation, as a new tag name is typed, existing tags in the MDB are searched in real time with SAYT results shown in the tag name box; if a matching tag name is not found in the MDB, a new tag name is automatically created. In one implementation, if the user made an error typing the tag name, the user would be given the option to reject the creation of a new tag name.

As shown in the embodiment of FIG. 3A, sidebar (300) may include a set of logical operators (shown at the top of sidebar (300) as logical operators (306)). The position of the logical operators (306), like the position of any other elements of sidebar (300), could be different than the position shown in FIG. 3A. In general, unless expressly indicated otherwise, the position of all GUI elements described in this application may be different than the position shown in the exemplary figures.

According to an embodiment of the present invention, data items can be filtered by opening a tag on its own, or many tags together. Setting the logical operators (306) in sidebar (300) of FIG. 3A allows tag contents (311) shown in FIG. 3B to be filtered by union, intersection, or exclusion of various tags. In the embodiment of FIG. 3B, filtered data items are displayed in results window (350).

According to an embodiment, as illustrated in FIG. 3B, data items can be searched via the results window search fields (312), which can be used in tandem with one another, and in tandem with tags. In this way search results are constrained as nested subsets of one another to efficiently converge on the desired data item(s).

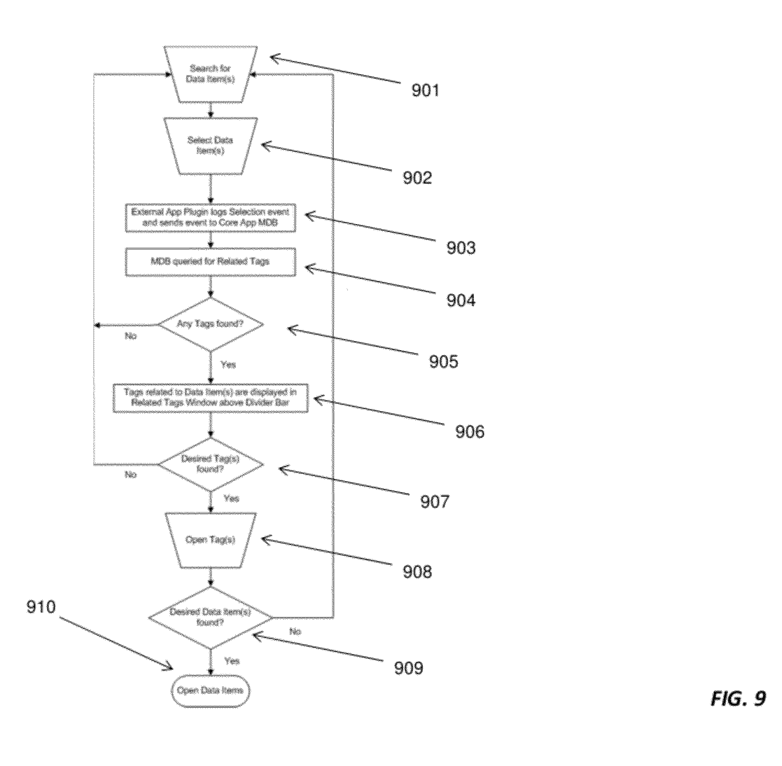

In one implementation, data items can also be used to find other data items using a process denoted “search by association”. When data items are selected in an external application or the results window, related tags are shown in a related tags window (302), as shown in FIG. 3A. In the representation of FIG. 3A, related tags window (302) is disposed above a divider bar (304). In various embodiments, the divider bar (304) may or may not exist, or multiple divider bars may be present. Related tags can then be opened to find other data items and other related tags. FIG. 9 provides additional details on how a search by association process could be performed in accordance with an embodiment of the present invention.

In the embodiment of FIG. 3B, the results window (350) includes two primary elements: the search fields (312) and the contents (311). The results window may be invoked by opening or closing a tag, using a hot key, using a mouse input, or otherwise interacting with the respective data processing system (e.g., a mouse, a keyboard, voice, user intention recognition technology (including optical, facial, or gesture recognition), a stylus, heuristic pointing recognition, or any method of interacting with a data processing system. In one implementation, the results window descends from the top of the screen in the foreground, overlapping other application windows, and can be hidden also using a hot key, using a mouse input or otherwise interacting with the respective data processing system.

In one embodiment of the present invention, data items are tagged by selecting them in either a results window or in an external application, and tagging them in a sidebar. In one implementation, the data items from one or more external applications are represented by links in the results window, (i.e. data items are not necessarily stored as copies in a local application's MDB), and data items may be managed in either the results window or in an external application with the same or similar effect.

In accordance with an embodiment of the present invention, data items can be tagged both manually by the user and automatically (“auto-tagged”) based on data item attributes. Automatic auto-tagging may be implemented in various embodiments using artificial intelligence algorithms, fuzzy logic engines, neural networks, rule-based processing, or any other approach that permits automatic data processing, and may include adding a tag to a data item, where the tag inherits one or more attributes of the respective data item, or a variation or adaptation of such attributes. Examples of auto-tag attributes include:
the folder in which an external application data item is filed;
the sender or recipient names in an email message
the date an email was sent
the date a particular data item was created or modified
the data source of the data item
any meta-data contained in an external application data item.

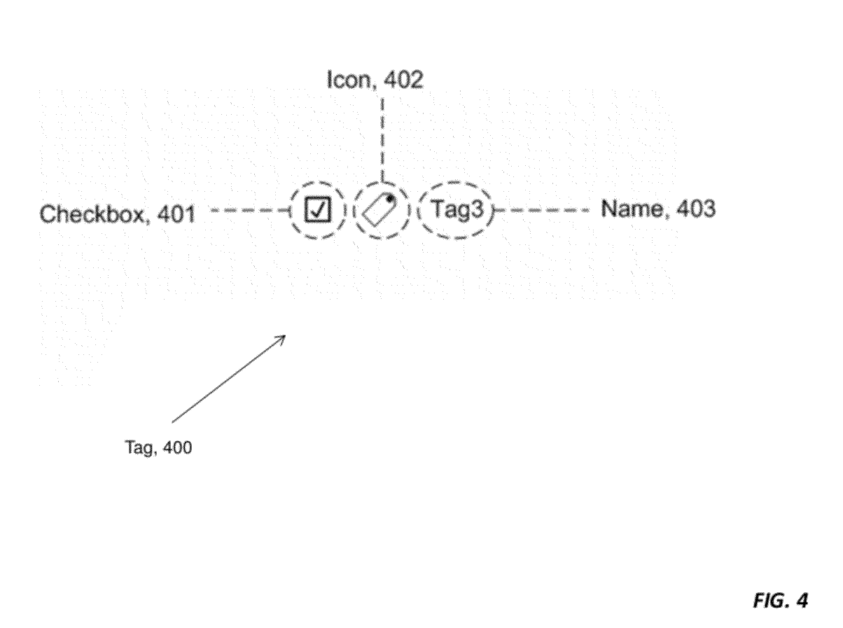

FIG. 4 shows details of select constituent components of a tag in accordance with an embodiment of the present invention. Tag (400) shown in FIG. 4 includes a checkbox (401), an icon (402) and a tag name (403). Checkbox (401) may be used to tag data items. Checkbox (401) may be displayed as a square that can be marked with an “X,” with a checkmark, or with any other indication designed to indicate that the currently selected data item is tagged. Alternatively, a checkbox may be displayed as any other GUI element that can be selected, marked or otherwise acted upon by a user. Icon (402) may include any graphical symbol or picture, or combination of symbols and/or pictures. In various implementations, any symbol or picture of icon (402) could be automatically or manually selected to provide a graphical indication of the nature, functionality or context of the tag. Tag name (403) provides a name for the tag, and may include any symbol, character or text, in any language or character set. In various implementations, the content of name (403) could be automatically or manually selected to provide an indication of the nature, functionality or context of the tag.

A taglet is a type of tag that, in various embodiments, may have similar characteristics as tags (e.g., it may include a checkbox, an icon and/or a name), and/or may perform functions similar to those of tags (e.g., it may categorize, filter, and/or indicate the tagged state of one or more data items). Additionally, in various embodiments, a taglet may perform certain actions on one or more data items. For example, a taglet may be able to initiate and/or manage uploading to a remote data processing system a digital photograph or a file, scheduling a meeting, and/or making a data entry on a web page. In general, in various specific embodiments, a taglet may be able to initiate and/or manage virtually any action or combination of actions that could be applied to one or more data items.

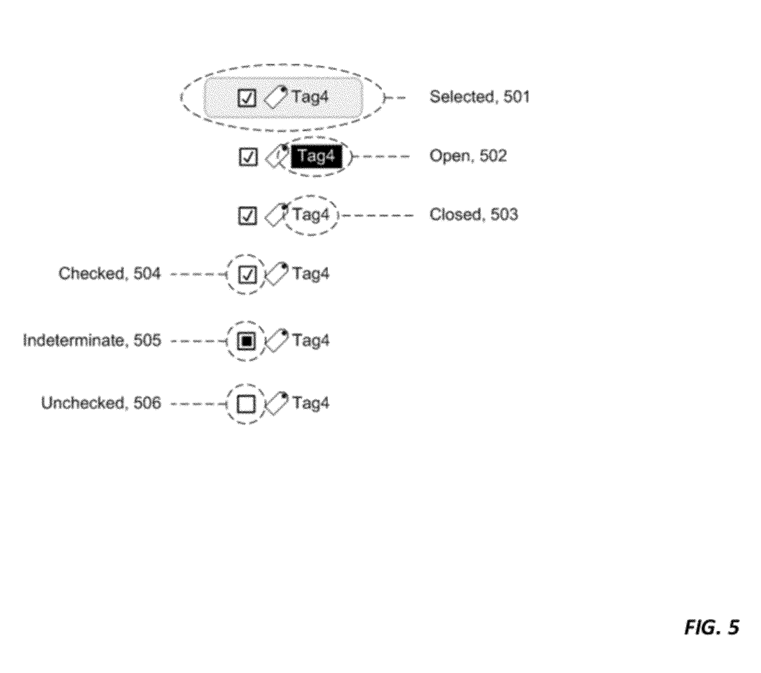

In one embodiment, the state of tag checkboxes conveys the relationships of tags to selected data items. FIG. 5 shows various available checkbox states in one implementation. In the implementation of FIG. 5, a tag could be “selected” as indicated by the highlight placed around the whole tag in position (501), could be “open” as indicated by the highlight placed around the name of the tag in position (502), could be “closed” as illustrated by the lack of highlighting in position (503), could be “checked” as identified by the checkmark shown in the checkbox in position (504), could be “indeterminate” as identified by the solid square shown in the checkbox in position (505), or could be “unchecked” as identified by the lack of any symbol in the checkbox in position (506). A tag may exhibit multiple characteristics simultaneously. For example, as shown in FIG. 5, the tag in position (502) is both open and checked.

### FingerTips

An embodiment of the invention provides a tool denoted “FingerTip” that facilitates the display of various tag attributes. Examples of tag attributes that may be displayed using FingerTips include:
Contact information such as phone numbers, email address, and address information relating to individuals, businesses or any other entities.
Social network profile information from social networking sites such as LinkedIn, Facebook, MySpace and any other website or service that provides such information.
Summary stock quote data, including charts, pricing information and any other financial or business-related data, which could be received from providers such as Yahoo, Google Finance or other website or service that provides such information.
Summary information of the data tagged by the tag, such as the volume of information, the number of data items tagged, the location of the items, or any other characteristics of such items.

The possible combinations of tag attributes that may be displayed using FingerTips is virtually unlimited.

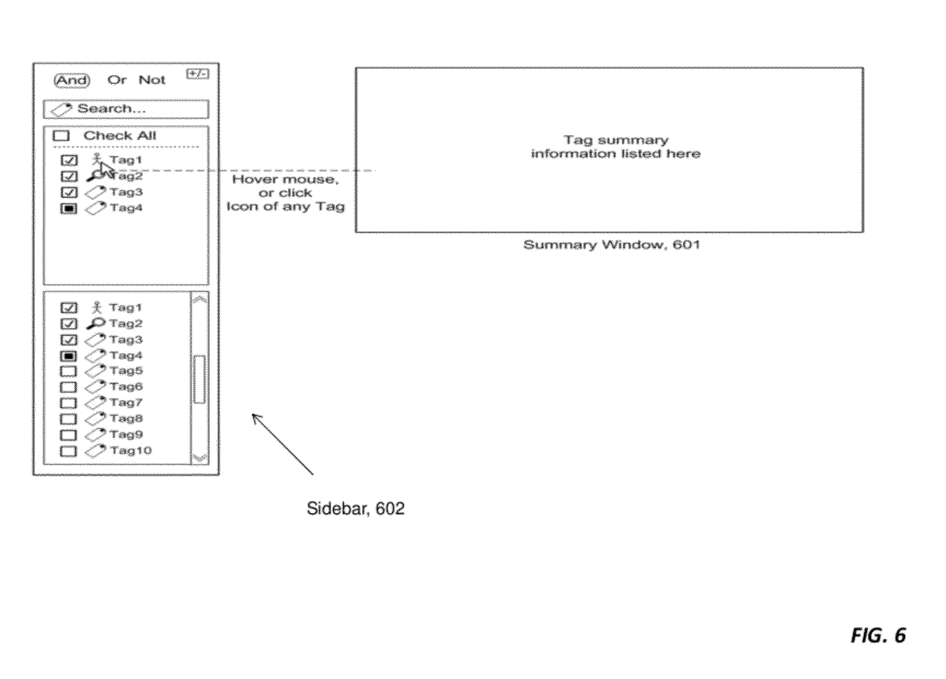

According to an embodiment of the invention shown in FIG. 6, tag summary information is displayed in a summary window (601), which is invoked by interaction with one or more tags shown in the sidebar (602). In various implementations, summary window (601) may be located and/or moved anywhere within the GUI, including partially or completely within sidebar (602). In an embodiment, FingerTips information is displayed in response to interaction with one or more data items. In one embodiment, FingerTips information is displayed in response to a combination of interactions with one or more tags, and one or more data items. In one implementation, FingerTips information is displayed in response to hovering a cursor over a tag or data item. In one implementation, FingerTips information is displayed in response to clicking on a tag or data item.

Exemplary Implementation: Fingertips—Interaction with A Tag

One exemplary implementation provides a data processing system comprising an operating system, a set of data processing modules, an application capable of running on the operating system, and a graphical user interface that includes a tag view area separate from the application, the set of data processing modules capable of:

displaying a data item within the graphical user interface;

displaying at least one tag in the tag view area, where the at least one tag corresponds to the displayed data item;

in response to a user interacting with at least one of the tags displayed in the tag view area, displaying information associated with the data item, the displayed information including data corresponding to the at least one application.

Examples of a data processing system that may be used to interact with a tag in various embodiments include a desktop computer, laptop, netbook, electronic notebook, client computing device, server computer, server system, cloud computing system, remote computer, mobile telephone, personal digital assistant, personal digital organizer, or any other device, component or system capable of processing data, including any electronic tablet or smartphone.

In the data processing system of this exemplary implementation, the displayed information further includes data obtained from a remote application.

In the data processing system of this exemplary implementation, the displayed information includes:

phone numbers, email address, address information, and any other contact information;

social network profile information from social networking sites (e.g., LinkedIn, Facebook, MySpace); and

Summary stock quote data, including charts and pricing information, received from data providers (e.g., Yahoo or Google Finance).

In the data processing system of this exemplary implementation, the at least one of the tags displayed in the tag view area corresponds to a set of additional data items, and the displayed information includes aggregated information relating to the displayed data item and to the set of additional data items (e.g., volume of information, number of data items tagged, etc.).

In the data processing system of this exemplary implementation, each tag is based on a set of characteristics of the corresponding data item.

In the data processing system of this exemplary implementation, the characteristics of the corresponding data item include one or more of the following: name of the data item, location of the data item within a corresponding file structure, name of a folder in which the data item is located, name of a sender of the data item, name of a recipient of the data item, date when the data item was sent, data source of the data item, meta-data corresponding to the data item, or content of the data item.

In the data processing system of this exemplary implementation, each data item includes one or more of the following: an email message, a digital photograph, a webmail message, a text message, a web bookmark, a network resource, an audio file, a video file, a result of a search, an individual piece of information stored in an electronic format that is part of a larger data set, or any other electronic file that can be accessed by the data processing system.

Exemplary Implementation: Fingertips—Interaction with A Data Item

One exemplary implementation provides a data processing system comprising an operating system, a set of data processing modules, an application capable of running on the operating system, and a graphical user interface that includes a tag view area separate from the application, the set of data processing modules capable of:

displaying a data item within the graphical user interface;

displaying at least one tag in the tag view area, where the tag corresponds to the displayed data item;

in response to a user interacting with the displayed data item, displaying information associated with the data item, the displayed information including data corresponding to the application.

In the data processing system of this exemplary implementation, the data processing system is a desktop computer, laptop, netbook, electronic notebook, client computing device, server computer, server system, cloud computing system, remote computer, mobile telephone, personal digital assistant, personal digital organizer, or any other device, component or system capable of processing data, including any electronic tablet or smartphone.

In the data processing system of this exemplary implementation, the displayed information further includes data obtained from a remote application.

In the data processing system of this exemplary implementation, the displayed information includes:

phone numbers, email address, address information, and any other contact information;

social network profile information from social networking sites (e.g., LinkedIn, Facebook, MySpace); and

Summary stock quote data, including charts and pricing information, obtained from data providers (e.g., Yahoo or Google Finance).

In the data processing system of this exemplary implementation, the at least one of the tags displayed in the tag view area corresponds to a set of additional data items, and the displayed information includes aggregated information relating to the displayed data item and to the set of additional data items.

In the data processing system of this exemplary implementation, the aggregated information includes the volume of information, the number of data items tagged, and any other attributes of the data item.

In the data processing system of this exemplary implementation, each tag is based on a set of characteristics of the corresponding data item.

In the data processing system of this exemplary implementation, the characteristics of the corresponding data item include one or more of the following: name of the data item, location of the data item within a corresponding file structure, name of a folder in which the data item is located, name of a sender of the data item, name of a recipient of the data item, date when the data item was sent, data source of the data item, meta-data corresponding to the data item, or content of the data item.

In the data processing system of this exemplary implementation, each data item includes one or more of the following: an email message, a digital photograph, a webmail message, a text message, a web bookmark, a network resource, an audio file, a video file, a result of a search, an individual piece of information stored in an electronic format that is part of a larger data set, or any other electronic file that can be accessed by the data processing system.

### Tag Grouping

In accordance with an embodiment of the present invention, a tag group is used to group tags together by a specific context so they can be more easily managed. Implementations include two types of tag groups: forced groups and natural groups.

### Forced Tag Groups

In one implementation illustrated in FIG. 7A, forced groups are displayed within sidebar (700) as group headers (703) in the all tags window, and can be expanded or collapsed by interacting with a corresponding GUI element as shown by (704), and respectively (705), to show, or respectively hide their tags.

In one embodiment, groups can be searched using a group search box (701) as illustrated in FIG. 7A in a manner similar to the way in which tags can be searched. Searching of tags was described in further detail in connection with the embodiment of FIG. 3A. Searching of groups can be implemented using a SAYT approach. Group searches can also be combined with tag searches to constrain results with both groups and tags. New groups can be created by clicking the new group icon (702) in the Group Search Box.

In one embodiment, group checkboxes have states that are similar to tag states. If no tags are checked or indeterminate in the group, the group could be shown as unchecked (708). If one or more tags are checked or indeterminate, but not all tags in the group are checked, the group checkbox could be shown as indeterminate (707). If all tags in the group are checked, then the group checkbox could be shown as checked (706). By checking the group checkbox successively, the tag checkbox states can be toggled from their original state, to checked, to unchecked, back to their original state again, all in a batch.

According to one embodiment, tags can be managed within groups by right clicking the group and selecting the appropriate context menu or by dragging and dropping tags in between tags in the related tags box or the all tags box. Examples of context menu items include:
add tags;
remove tags;
delete tags;
move tags.

### Natural Tag Groups

FIG. 7B shows a natural tag group in accordance with an implementation of the present invention. In this implementation, semantically similar tags are grouped together automatically, as illustrated in the all tags window (303) from FIG. 3A. Automatic grouping may be achieved, in various embodiments, using artificial intelligence algorithms, fuzzy logic engines, neural networks, rule-based processing, or any other approach that permits automatic data processing. In various embodiments, criteria for automatic grouping of tags include:
relationship of the respective tags or corresponding data items to other tags or other data items;
suggestions through connections to social tagging sites like www.delicious.com;
synonyms of words;
any other relationships contained within the data that could serve as the basis for establishing a logical or semantic connection.

In one embodiment, grouping is implied merely by the sort order of the tags in the sidebar. For example, as shown by the subset of tags denoted (709) in FIG. 7B, the tag “cat” might be automatically grouped with related tags such as “dog”, “mouse”, “animal”, and “feline” based on the fact that all of these tags have a common logical connection.

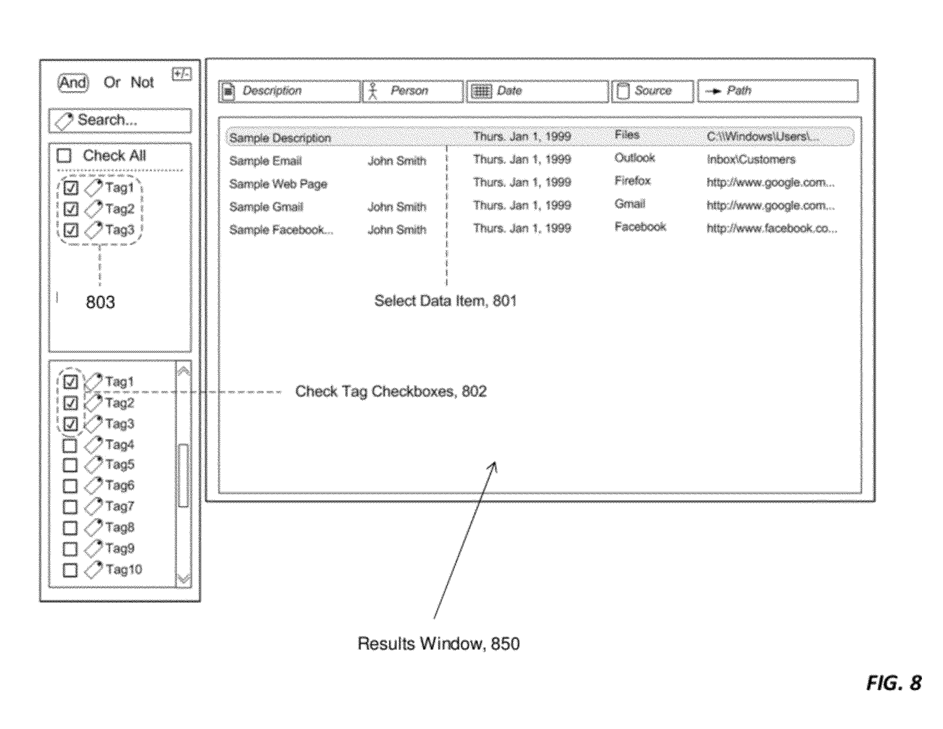

FIG. 8 illustrates a process for tagging data items in accordance with an embodiment of the present invention. In one implementation, these steps are substantially identical to those used for tagging data items in external applications. In one implementation, gagging data items may include the following steps:
a data item (801) is selected in a results window (850); and
one or more tag checkboxes are checked (802)

### Batch Tagging

In one embodiment, selected data items can be tagged all at once (“Batch tagged”) using a group checkbox (shown as group checkboxes (706), (707), and (708) in FIG. 7A) and checking all corresponding tags in the respective group, which may save time. In general, one tag could be used to add multiple tags in a hierarchical relationship.

### Exemplary Implementation: Batch Tagging

One exemplary implementation provides a data processing system comprising a set of data processing modules, the set of data processing modules capable of:

assigning at least one tag to a plurality of data items, each tag including a set of tag attributes;

defining a set of tag components for each of the assigned tags;

forming a group of at least two assigned tags, the group having a set of group components; and

in response to a command, changing at least one attribute of each tag in the group of assigned tags.

In the data processing system of this exemplary implementation, at least one tag component of each assigned tag is a checkbox and at least one of the group components is a group-level checkbox.

In the data processing system of this exemplary implementation, the changing at least one attribute of each tag consists of assigning a name to each tag in the group of assigned tags, and the command includes a user checking the group-level checkbox.

In the data processing system of this exemplary implementation, the group of at least two assigned tags is formed based on input received from a user.

In the data processing system of this exemplary implementation, the group of at least two assigned tags is formed automatically based on one or more attributes of each tag included in the group.

In the data processing system of this exemplary implementation, the data processing system is a desktop computer, laptop, netbook, electronic notebook, client computing device, server computer, server system, cloud computing system, remote computer, mobile telephone, personal digital assistant, personal digital organizer, or any other device, component or system capable of processing data, including any electronic tablet or smartphone.

In the data processing system of this exemplary implementation, the assignment of each tag is based on a set of characteristics of the corresponding data item.

In the data processing system of this exemplary implementation, the characteristics of the corresponding data item include one or more of the following: name of the data item, location of the data item within a corresponding file structure, name of a folder in which the data item is located, name of a sender of the data item, name of a recipient of the data item, date when the data item was sent, data source of the data item, meta-data corresponding to the data item, or content of the data item.

In the data processing system of this exemplary implementation, each data item includes one or more of the following: an email message, a digital photograph, a webmail message, a text message, a web bookmark, a network resource, an audio file, a video file, a result of a search, an individual piece of information stored in an electronic format that is part of a larger data set, or any other electronic file that can be accessed by the data processing system.

In the data processing system of this exemplary implementation, the identifying a group of related tags is made in response to input received from a user.

In the data processing system of this exemplary implementation, the identifying a group of related tags is made automatically based on one or more characteristics of at least one of the corresponding assigned tags.

In the data processing system of this exemplary implementation, the automatic identifying a group of related data items is made using at least one artificial intelligence algorithm, at least one fuzzy logic engine, at least one neural network, at least one rule, any other automatic data processing approach, or any combination of the foregoing.

In the data processing system of this exemplary implementation, the characteristics of at least one of the corresponding assigned tags include:

relationship of at least one data item with at least one other substantially similar data item;

suggestions through connections to social tagging sites (e.g., including www.delicious.com);

synonyms of words;

any other logical or semantic relationships contained within the data items; or

any combination of the foregoing.

### Tag Searches

FIG. 9 illustrates a process for searching for data items in accordance with an embodiment of the invention. In one implementation, the search process is implemented using a search by association algorithm. The search process may run on a data processing system.

In one embodiment, a search by association allows a user to find a data item through an iterative process of selection and discovery. This would enable a user to find a data item, even if the user does not know exactly what the user is seeking. In one implementation, a search by association is conceptually similar to a human interaction process where one person is asking another person questions to narrow down a search.

In the embodiment of FIG. 9, to conduct a search for a data item, in step (901), a user may type search criteria into a results window to find tagged data items directly. An example of a results window is results window (350) shown in FIG. 3B. Criteria could be typed into one field or a combination of many fields to narrow down results.

In step (902), the user selects one of more data items in the results window.

In step (903), one or more external application plugins log the selection event and sends data relating to the event to a core application MDB. The core application receives the data as a result of the selection event and is capable of processing the received data.

In step (904), the MDB is queried for related tags. In one embodiment, the selection event sent by the application plugin in step (903) is processed by the MDB for related tags.

In step (905), a decision is made whether any tags were found. If the decision is negative, the search process may be restarted.

If the decision in step (905) is positive, in step (906) tags related to one or more data items are displayed in a related tags window above a divider bar, showing to the user what is related to the selected data items. In alternative embodiments, there may be no divider bar, there may be multiple divider bars, and/or one or more data items may be shown in other areas of the GUI.

In step (907), a decision is made whether one or more of the tags desired were found. This decision may be made at least in part based on input received from the user. If the decision is negative, the search process may be restarted.

If the decision is positive, in step (908) tags that were found may be opened. In one implementation, tags may be double clicked to filter by applicable categories.

In step (909), a decision is made whether one or more of the tags desired were found. Analogous to the decision in step (907), this decision may be made at least in part based on input received from the user. If the decision is negative, the search process may be restarted.

In step (910), the user may open the data items that were found. In one implementation, the user may double click one or more of the data items found to open them.

### The Stage

An embodiment of the invention provides a “stage.” A stage is a versatile workspace with functionality similar to that of a visual clipboard, where the user may drag and drop items from different sources in order to link them together easily. The stage allows the user to see a number of items together and maintain the tagging context of one or more actions performed on tags or data items.

In one embodiment, for example, a user may want to link a file form an email program (e.g., a Microsoft Outlook email) to a file from a web browser (e.g., a web page viewed in Internet Explorer). In order to do this without the stage, the user would normally find the email in Outlook, tag it with the desired tags, then switch views to Explorer (or the results window), find the desired file, then search for the same tags and tag the file. This requires the user to remember a lot of information for the entire operation, which may interfere with other activities in which the user may be engaged at that time.

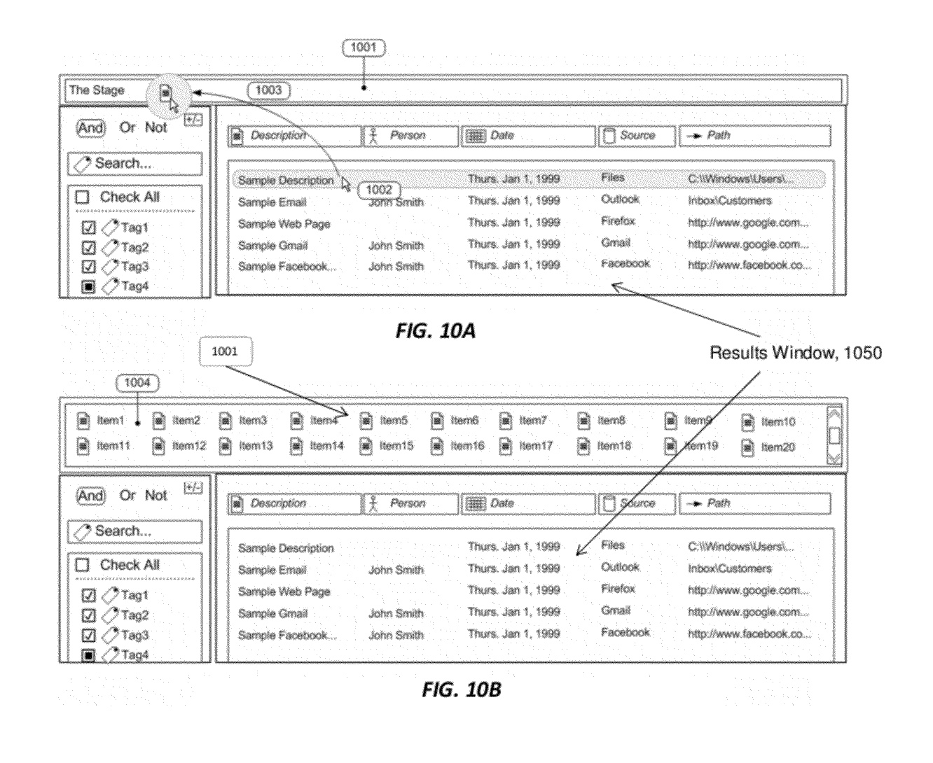

According to an embodiment illustrated in FIG. 10, a stage (1001) is invoked by dragging a data item (1002) to the top of the screen above the results window and dropping the data item onto the stage, where it shown via an corresponding icon, name, text or other applicable indicator (1003). Data items can be dragged and dropped on the stage from any location or source, including from external applications and from a results window (such as results window (1050)).

In various embodiments, the stage could be located anywhere within the GUI, and could have any shape or size that can be displayed fully or partially. For example, the stage (1001) shown in FIG. 10A has a single row width and is located above results window (1050). In contrast, the stage (1001) shown in FIG. 10B has a double row width to display additional items, but is still located above results window (1050). In one implementation, the stage can auto-tile and push all other windows downward, including the results window. This would permit maintaining a clear view of the staged items. Items (1004) in the stage of FIG. 10B may be selectable and can have all of the same interactions with tags as when they are selected in the results window.

In one embodiment, the Stage can be cleared by:
selecting any or all of the items located there and deleting them with the Delete key or using ctrl-x.
clicking a “Clear Stage” button (e.g., located at the top of the screen). This button could replace or be adjacent to the stage label denoted “The Stage” and shown in FIG. 10A when any items are dragged into the stage.

In one implementation, a stage toggle button may be provided (e.g., somewhere at the top of the sidebar, or at the top of the results window) that can turn the stage on and off. This is in case the user does not want to experience the tiling effect of the stage when moving a cursor to the top of the screen.

### External Applications

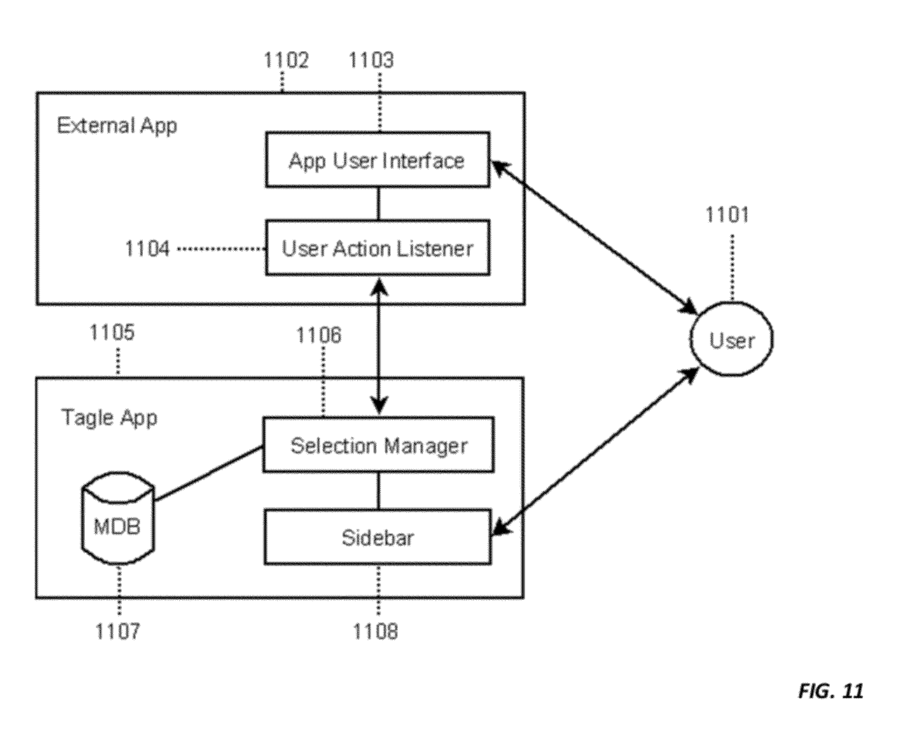

FIG. 11 illustrates an embodiment of the present invention where data items selected in an external application (1102) may be tagged using a sidebar (1108). A user (1101) using a data processing system (not shown in FIG. 11) interacts with the user interface (1103) of an external application (1102) and selects one or more data items. A user action listener module (1104) listens to user actions that take place in the user interface (1103) of the external application (1102). A listener module (1104) infers the data items selected by the user (1101) and communicates this to a selection manager module (1106) of a tagle application (1105). In one embodiment, external application (1102) runs on data processing system 1412 illustrated in FIG. 14.

In one embodiment, the selection manager module (1106) interacts with an MDB (1107) and uses the selection of data items passed by the user action listener module (1104) to decide the state of each tag (for example the tags (504-506) of FIG. 5) that may be shown in sidebar (1108). The user (1101) then interacts with the sidebar (1108) to tag the data items selected in the external application (1102). When the user performs the tagging action in the sidebar (1108), the selection manager module (1106) interacts with the MDB (1107) to associate/dissociate the selected data items with the tags that are checked.

In one implementation, the process for tagging data items in a results window (e.g., the results window (202) shown in FIG. 2A) of a local application is substantially similar. In one embodiment, the user action listener module (1104) interacts with a results window located within the same data processing system rather than an external application (1102).

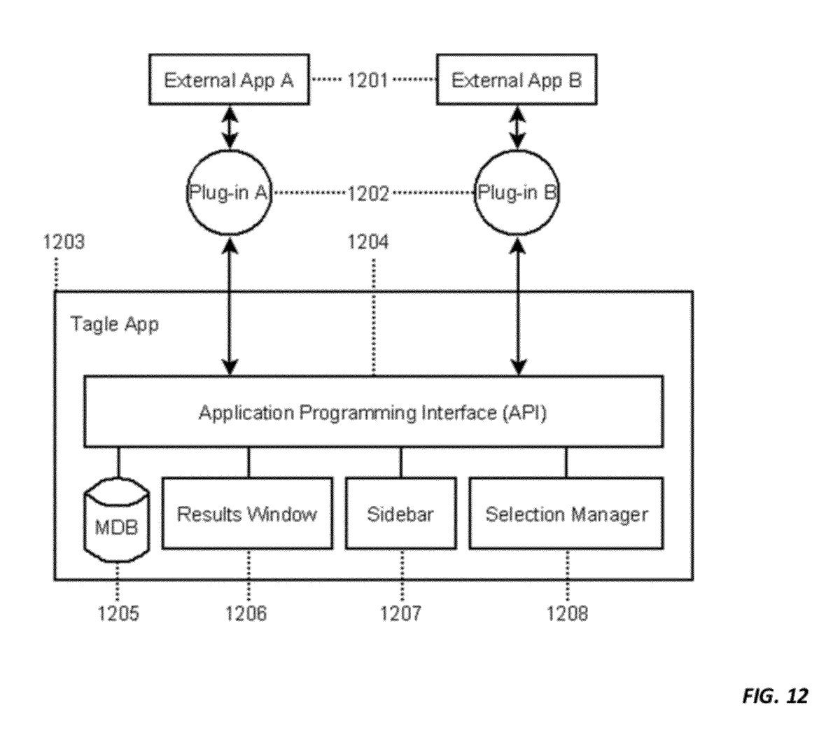

FIG. 12 illustrates an embodiment of the present invention where the process of communication between one or more external applications (1201) and a tagle application (denoted as “Tagle App” (1203) in FIG. 12) can be accomplished by independent modules acting as plug-ins (1202). In one embodiment, any or all of the one or more external applications (1201) run on data processing system 1412 illustrated in FIG. 14.

In one implementation, plug-ins (1202) are developed, packaged and deployed separately from the tagle application (1203). An API (1204) facilitates communications. The embodiment of FIG. 12 further includes a selection manager module (1208), a sidebar (1207), a results window (1206) and an MDB (1205). The API (1204) facilitates interaction between one or more plug-ins (1202) on the one side and the selection manager module (1208), the sidebar (1207), the results window (1206) and the MDB (1205) on the other side. In one implementation, a plug-in (1202) listens to user interface actions in the external application (1201), and communicates details to various portions of a local tagle application (1203) using the API (1204).

### Exemplary Implementation: Single Data Processing System

One exemplary implementation provides a data processing system comprising an operating system, a set of data processing modules, a first application and a second application, the first application and the second application capable of running on the operating system, the set of data processing modules capable of:

assigning at least one tag to each data item included in a first set of data items, the first set of data items corresponding to the first application;

assigning at least one tag to each data item included in a second set of data items, the second set of data items corresponding to the second application; and

identifying a group of related data items based on corresponding assigned tags, the group of related data items including at least one data item corresponding to the first application and at least one data item corresponding to the second application.

The data processing system of this exemplary implementation may be a desktop computer, laptop, netbook, electronic notebook, client computing device, server computer, server system, cloud computing system, remote computer, mobile telephone, personal digital assistant, personal digital organizer, or any other device, component or system capable of processing data, including any electronic tablet or smartphone.

In the data processing system of this exemplary implementation, the assignment of each tag is based on a set of characteristics of the corresponding data item.

In the data processing system of this exemplary implementation, the characteristics of the corresponding data item include one or more of the following: name of the data item, location of the data item within a corresponding file structure, name of a folder in which the data item is located, name of a sender of the data item, name of a recipient of the data item, date when the data item was sent, data source of the data item, meta-data corresponding to the data item, or content of the data item.

In the data processing system of this exemplary implementation, each data item includes one or more of the following: an email message, a digital photograph, a webmail message, a text message, a web bookmark, a network resource, an audio file, a video file, a result of a search, an individual piece of information stored in an electronic format that is part of a larger data set, or any other electronic file that can be accessed by the data processing system.

In the data processing system of this exemplary implementation, the identifying a group of related data items based on corresponding assigned tags is made, possibly via a forced tag group, in response to a user assigning one or more characteristics of at least one of the corresponding assigned tags.

In the data processing system of this exemplary implementation, the identifying a group of related data items based on corresponding assigned tags is made automatically, possibly via a natural tag group, based on one or more characteristics of at least one of the corresponding assigned tags.

In the data processing system of this exemplary implementation, the automatic identifying a group of related data items is made using at least one artificial intelligence algorithm, at least one fuzzy logic engine, at least one neural network, at least one rule, any other automatic data processing approach, or any combination of the foregoing.

In the data processing system of this exemplary implementation, the characteristics of at least one of the corresponding assigned tags include:

relationship of at least one data item with at least one other substantially similar data item;

suggestions through connections to social tagging site (e.g., www.delicious.com); synonyms of words;

any other logical or semantic relationships contained within the data items; or

any combination of the foregoing.

### Exemplary Implementation: Two Remote Data Processing Systems

One exemplary implementation provides a data processing system comprising a set of data processing modules, the set of data processing modules capable of:

assigning at least one tag to each data item included in a first set of data items, the first set of data items corresponding to a first application, the first application running on a remote data processing system;

assigning at least one tag to each data item included in a second set of data items, the second set of data items corresponding to a second application, the second application running on a remote data processing system; and

identifying a group of related data items based on corresponding assigned tags, the group of related data items including at least one data item corresponding to the first application and at least one data item corresponding to the second application.

In the data processing system of this exemplary implementation, the data processing system is a desktop computer, laptop, netbook, electronic notebook, client computing device, server computer, server system, cloud computing system, remote computer, mobile telephone, personal digital assistant, personal digital organizer, or any other device, component or system capable of processing data, including any electronic tablet or smartphone.

In the data processing system of this exemplary implementation, the assignment of each tag is based on a set of characteristics of the corresponding data item.

In the data processing system of this exemplary implementation, at least one tag assigned to each of the data items included in the group of related data items is the same.

In the data processing system of this exemplary implementation, the characteristics of the corresponding data item include one or more of the following: name of the data item, location of the data item within a corresponding file structure, name of a folder in which the data item is located, name of a sender of the data item, name of a recipient of the data item, date when the data item was sent, data source of the data item, meta-data corresponding to the data item, or content of the data item.

In the data processing system of this exemplary implementation, each data item includes one or more of the following: an email message, a digital photograph, a webmail message, a text message, a web bookmark, a network resource, an audio file, a video file, a result of a search, an individual piece of information stored in an electronic format that is part of a larger data set, or any other electronic file that can be accessed by the data processing system.

In the data processing system of this exemplary implementation, the identifying a group of related data items based on corresponding assigned tags is made, possibly via a forced tag group, in response to a user assigning one or more characteristics of at least one of the corresponding assigned tags.

In the data processing system of this exemplary implementation, the identifying a group of related data items based on corresponding assigned tags is made automatically (possibly via a natural tag group) based on one or more characteristics of at least one of the corresponding assigned tags.

In the data processing system of this exemplary implementation, the automatic identifying a group of related data items is made using at least one artificial intelligence algorithm, at least one fuzzy logic engine, at least one neural network, at least one rule, any other automatic data processing approach, or any combination of the foregoing.

In the data processing system of this exemplary implementation, the characteristics of at least one of the corresponding assigned tags include:

relationship of at least one data item with at least one other substantially similar data item;

suggestions through connections to social tagging sites, (e.g., www.delicious.com); synonyms of words;

any other logical or semantic relationships contained within the data items; or

any combination of the foregoing.

### Exemplary Implementation: Tag Grouping

One exemplary implementation provides a data processing system comprising a set of data processing modules, the set of data processing modules capable of:

assigning at least one tag to each data item included in a first set of data items, the first set of data items corresponding to a first application;

assigning at least one tag to each data item included in a second set of data items, the second set of data items corresponding to a second application; and

identifying a group of related tags, the group of related tags including at least one tag assigned to a data item corresponding to the first application and at least one tag assigned to a data item corresponding to the second application.

In the data processing system of this exemplary implementation, the identifying of related tags is made based on characteristics of the tags.

In the data processing system of this exemplary implementation, the identifying of related tags is made based on characteristics of the data items to which the tags are assigned.

In the data processing system of this exemplary implementation, the data processing system is a desktop computer, laptop, netbook, electronic notebook, client computing device, server computer, server system, cloud computing system, remote computer, mobile telephone, personal digital assistant, personal digital organizer, or any other device, component or system capable of processing data, including any electronic tablet or smartphone.

In the data processing system of this exemplary implementation, the first application is running on the data processing system, and the second application is running on a remote data processing system.

In the data processing system of this exemplary implementation, the first application and the second application are running on the data processing system.

In the data processing system of this exemplary implementation, the assignment of each tag is based on a set of characteristics of the corresponding data item.

In the data processing system of this exemplary implementation, the characteristics of the corresponding data item include one or more of the following: name of the data item, location of the data item within a corresponding file structure, name of a folder in which the data item is located, name of a sender of the data item, name of a recipient of the data item, date when the data item was sent, data source of the data item, meta-data corresponding to the data item, or content of the data item.

In the data processing system of this exemplary implementation, each data item includes one or more of the following: an email message, a digital photograph, a webmail message, a text message, a web bookmark, a network resource, an audio file, a video file, a result of a search, an individual piece of information stored in an electronic format that is part of a larger data set, or any other electronic file that can be accessed by the data processing system.

In the data processing system of this exemplary implementation, the identifying a group of related tags is made in response to input received from a user.

In the data processing system of this exemplary implementation, the identifying a group of related tags is made automatically based on one or more characteristics of at least one of the corresponding assigned tags.

In the data processing system of this exemplary implementation, the automatic identifying a group of related data items is made using at least one artificial intelligence algorithm, at least one fuzzy logic engine, at least one neural network, at least one rule, any other automatic data processing approach, or any combination of the foregoing.

In the data processing system of this exemplary implementation, the characteristics of at least one of the corresponding assigned tags include:

relationship of at least one data item with at least one other substantially similar data item;

suggestions through connections to social tagging sites (e.g., www.delicious.com); synonyms of words;

any other logical or semantic relationships contained within the data items; or

any combination of the foregoing.

Exemplary Implementation: All Tags and Related Tags Sidebars GUI—Interaction with A Data Item:

One exemplary implementation provides a data processing system comprising:

a graphical user interface, the graphical user interface including a first tag view area and a second tag view area; and

a set of modules, the set of modules capable of:
displaying within the first tag view area at least one tag assigned to a data item; and
in response to a user interacting within the graphical user interface with the data item, displaying at least one related tag in the second tag view area, wherein the at least one related tag corresponds to the data item.

In the data processing system of this exemplary implementation, the data processing system is a desktop computer, laptop, netbook, electronic notebook, client computing device, server computer, server system, cloud computing system, remote computer, mobile telephone, personal digital assistant, personal digital organizer, or any other device, component or system capable of processing data, including any electronic tablet or smartphone.

In the data processing system of this exemplary implementation, the assignment of each tag is based on a set of characteristics of the corresponding data item.

In the data processing system of this exemplary implementation, the characteristics of the corresponding data item include one or more of the following: name of the data item, location of the data item within a corresponding file structure, name of a folder in which the data item is located, name of a sender of the data item, name of a recipient of the data item, date when the data item was sent, data source of the data item, meta-data corresponding to the data item, or content of the data item.

In the data processing system of this exemplary implementation, each data item includes one or more of the following: an email message, a digital photograph, a webmail message, a text message, a web bookmark, a network resource, an audio file, a video file, a result of a search, an individual piece of information stored in an electronic format that is part of a larger data set, or any other electronic file that can be accessed by the data processing system.

Exemplary Implementation: All Tags and Related Tags Sidebars GUI—Interaction with A Tag:

One exemplary implementation provides a data processing system comprising:

a graphical user interface, the graphical user interface including a first tag view area and a second tag view area; and

a set of modules, the set of modules capable of:
displaying within the first tag view area at least one tag assigned to a data item; and
in response to a user interacting with one or more of the tags displayed in the first tag view area, displaying at least one related tag in the second tag view area, wherein the at least one related tag corresponds to the data item.

In the data processing system of this exemplary implementation, the data processing system is a desktop computer, laptop, netbook, electronic notebook, client computing device, server computer, server system, cloud computing system, remote computer, mobile telephone, personal digital assistant, personal digital organizer, or any other device, component or system capable of processing data, including any electronic tablet or smartphone.

In the data processing system of this exemplary implementation, the assignment of each tag is based on a set of characteristics of the corresponding data item.

In the data processing system of this exemplary implementation, the characteristics of the corresponding data item include one or more of the following: name of the data item, location of the data item within a corresponding file structure, name of a folder in which the data item is located, name of a sender of the data item, name of a recipient of the data item, date when the data item was sent, data source of the data item, meta-data corresponding to the data item, or content of the data item.

In the data processing system of this exemplary implementation, each data item includes one or more of the following: an email message, a digital photograph, a webmail message, a text message, a web bookmark, a network resource, an audio file, a video file, a result of a search, an individual piece of information stored in an electronic format that is part of a larger data set, or any other electronic file that can be accessed by the data processing system.

### Taglets

In accordance with an embodiment of the present invention, a taglet may perform every function of a tag, plus additional functions. In one implementation, tagging data items with taglets and managing and interacting with taglets are substantially similar as tagging data items with tags, and respectively managing and interacting with tags, including the following:
data items may be selected, then may be tagged with taglets
taglets may be opened and closed

What happens with a data item once it is tagged with a taglet, however, goes further than simple categorization. The following are examples of two taglets:

### Photo Uploader Taglet (“PUT”)

In accordance with an embodiment of the present invention, digital photos can be uploaded into a data sharing website, network or service (e.g., Facebook) via a photos link in a user's profile using an improved process. A photo uploader taglet (denoted a “PUT”) implementation may simplify this procedure to essentially one click, directly from a generic file viewer such as Windows Explorer running on a local data processing system. In one embodiment, the procedure is as follows:
select photos
tag photos with the PUT

Once tagged, in one embodiment, the photos are automatically uploaded to the user's photo sharing account. If the account allows it, the tags related to the photos may be uploaded along with the photos. All this may happen without the need to expressly login to the photo sharing account at that time to manually carry out individual steps. If needed, the PUT could rely on pass-through authentication, pre-stored user credentials, or any other method of dynamic user authentication by the respective photo sharing account.

### Email Share Taglet (“EST”)

In accordance with an embodiment of the present invention, an email share taglet (denoted “EST”) allows a user to share data items and their tags via email. In one implementation, this process works as follows:
select a data item in either an external application or in a results window
tag the data item with the EST.

In accordance with an embodiment of the present invention, data items are sent via a user's default email client with their tags (if any) appended to the email subject line. The tags are prefixed with some additional text that allows the tags to be recognized by the receiver's email client, another application or other module associated with the receiver, and/or an MDB associated with the receiver. Upon being recognized, the tags appended in the subject line of the EST email can be parsed out and added to the receiver's MDB. The EST email can then also be tagged with the tags appended to the subject line of the EST email.

In various embodiments, taglets may have any number of other uses, including the following:
Sharing other types of information or their tags on social networks, online bookmarking sites such as www.delicious.com, blogs, and other online media
Moving data items or their tags to central servers
Uploading data items or their tags to an order management system or other type of database
Upload videos to YouTube or other video-oriented websites or services
Schedule calendar events.
A “Twitter Taglet” could be designed to interface with the Twitter website and could send out a twitter of selected data item text, or a URL, or any other data
Attach email and files to database information (e.g., could relate external data to MDB data)
Create related notes to data items (e.g., launch a Notepad application to create a note related to an email)
Create maps of data items based on geographic tags associated to the data item (e.g., a photo tagged with San Francisco and Fisherman's Wharf could be mapped there)
A “Zip Taglet” could zip up data item(s) and tags(s) and package them in one or more compressed data files. In an alternative implementation, some or all of the respective data files could be encrypted.
An “Email Share Taglet” could allow a tag structure to be shared via email by appending tags to email subject lines
A “Social Share Taglet” could share a tagged URL with a social network using a process similar to the one described above in connection with the photo uploader taglet.

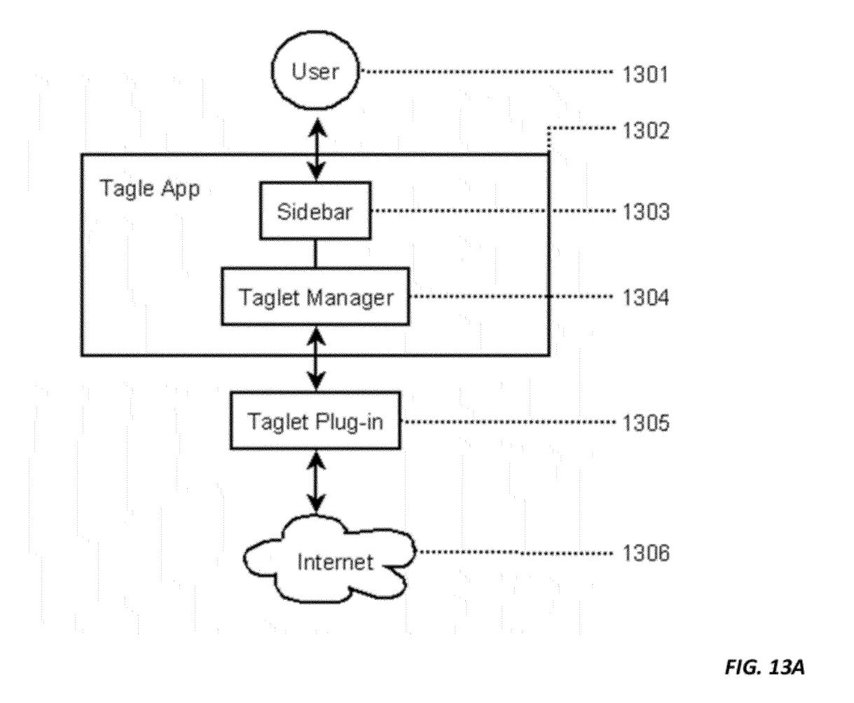

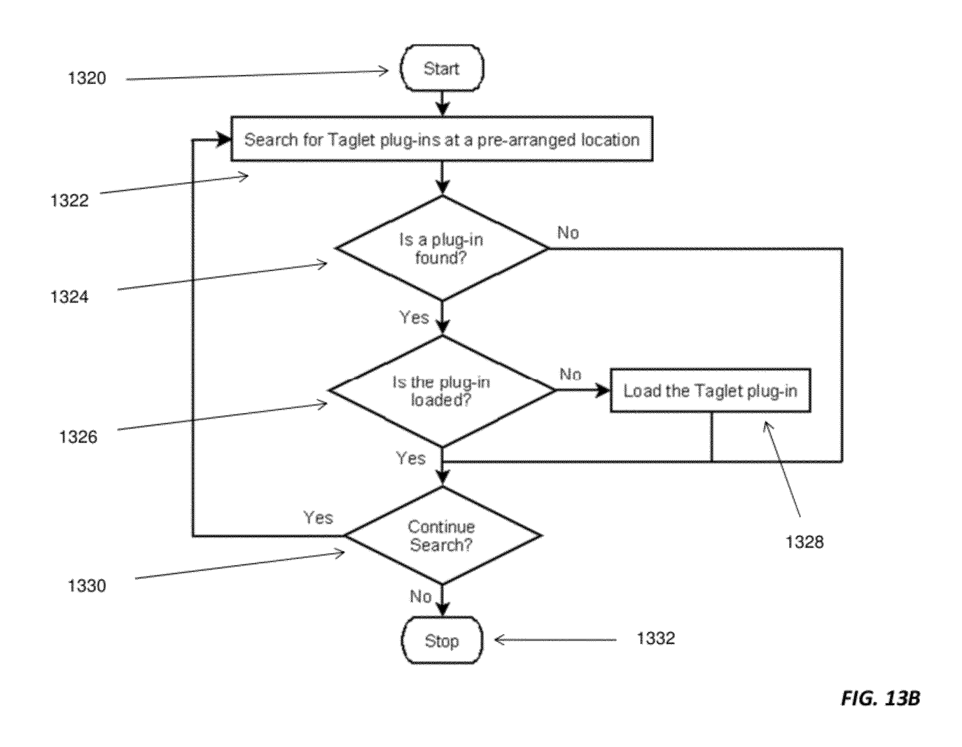

In accordance with an embodiment of the present invention, FIG. 13A and FIG. 13B illustrate a system whereby a tagle application (denoted as “Tagle App” (1302) in FIG. 13A) can work with a wide variety of taglet plug-ins.

FIG. 13A illustrates an implementation where the act of tagging a data item with a taglet leads to an action being executed. In this implementation, a user (1301) selects certain data items, possibly in the results window or an external application. The user then tags these items with a taglet using a sidebar (1303). When this information is passed to the taglet manager module (1304), the taglet manager module (1304) first ascertains the type of the taglet that the user has checked. The taglet manager module (1304) then chooses the corresponding taglet plug-in (1305) from among those loaded and informs the selected plug-in of the data items that the user had selected when the taglet was checked. The taglet plug-in (1305) then performs the appropriate action (for example, upload the photos represented by the data items to a photo sharing application on the Internet (1306)). In one implementation, the Internet (1306) network is one of the data networks (1408) and (1410) shown in the embodiment of FIG. 14.

FIG. 13B depicts a process by which, in an embodiment of the invention, a tagle application dynamically discovers the kinds of taglets available. This search process may be executed on a data processing system. In one implementation, the tagle application does this by looking for taglet plug-ins in a pre-arranged location (for example: a particular directory in a hard disk). Taglets can indicate their presence at this location (for example, by writing or modifying a file in that directory). All or some of the detected taglets may then be loaded by the tagle application so that they can be used at a later time.

In the embodiment of FIG. 13B, the search begins in step (1320). In step (1322), the system searches for one or more corresponding taglet plug-ins at a prearranged location. A decision is made in step (1324) whether at least one plug-in was found. If the decision is negative, the system continues execution in step (1330).

If the decision in step (1324) is positive, in step (1326) a decision is made whether the plug-in found in step (1324) is loaded. If the decision is negative, indicating that the plug-in is not loaded, the respective plug-in is loaded in step (1328).

If the decision in step (1326) is positive, in step (1330) a decision is made whether to continue the search. If the decision is positive, the system restarts the process in step (1322). If the decision is negative, the search is stopped in step (1332).

### Exemplary Implementation: Taglets

One exemplary implementation provides a data processing system capable of communicating with a remote application, the data processing system comprising a set of modules, the set of modules capable of:

selecting at least one data item from a plurality of data items;

assigning at least one taglet to each of the selected data items, and

upon assignment of a taglet to a particular selected data item, initiating an operation in connection with the remote application, wherein the remote application is not a process supporting an email program.

In the data processing system of this exemplary implementation, the data processing system is a desktop computer, laptop, netbook, electronic notebook, client computing device, server computer, server system, cloud computing system, remote computer, mobile telephone, personal digital assistant, personal digital organizer, or any other device, component or system capable of processing data, including any electronic tablet or smartphone.

In the data processing system of this exemplary implementation, the remote application runs on a remote data processing system and provides photo sharing functionality, and the operation includes uploading a photograph to another data processing system.

In the data processing system of this exemplary implementation, the operation and the remote application are as follows:

Sharing data items or their tags on social networks, online bookmarking sites such as www.delicious.com and others, blogs, and other online media;

Moving data items or their tags to a remote data processing system;

Uploading data items or their tags to an order management system or other type of database;

Uploading one or more videos to YouTube and other websites or servers;

Scheduling calendar events;

sending out a message (e.g., twitter) of selected data item text, or a URL, or any other data;

attaching one or more emails or files to information included in a database, or otherwise relating external data to information included in a database;

creating related notes to data items (e.g., launching Microsoft Notepad to create a related note to an email)

Creating maps of data items based on geographic tags associated to the data item (e.g., a photo tagged with San Francisco and Fisherman's Wharf will be mapped there)

Digital compression of one or more data items or tags

Sharing a tag structure via email by appending tags to email subject lines

Sharing a tagged URL to social networks, wherein each social network may have a separate tag and operation associated with it; and

Any combination of the foregoing.

In the data processing system of this exemplary implementation, each assigned taglet is based on a set of characteristics of the corresponding data item.

In the data processing system of this exemplary implementation, the characteristics of the corresponding data item include one or more of the following: name of the data item, location of the data item within a corresponding file structure, name of a folder in which the data item is located, name of a sender of the data item, name of a recipient of the data item, date when the data item was sent, data source of the data item, meta-data corresponding to the data item, or content of the data item.

In the data processing system of this exemplary implementation, each data item includes one or more of the following: an email message, a digital photograph, a webmail message, a text message, a web bookmark, a network resource, an audio file, a video file, a result of a search, an individual piece of information stored in an electronic format that is part of a larger data set, or any other electronic file that can be accessed by the data processing system.

FIG. 14 shows an overview of a system that could accommodate various embodiments of the present invention. As shown in FIG. 14, a number of data processing devices (1402), (1404) and (1406) that may be utilized by one or more users are coupled to two networks (1408) and (1410). A data processing system (1412) is also connected to the two networks (1408) and (1410). In various implementations, each of the data processing devices (1402), (1404) and (1406) may be connected to one or more networks (e.g., a laptop or netbook computer may be connected to both a wired Ethernet network and to a cellular, WiMAX or WiFi network), or may not be connected to any network at least temporarily. In various embodiments, each of the data processing devices (1402), (1404) and (1406) is connected to one or more of the data networks (1408) and (1410), and/or to other networks not shown in FIG. 14.

In various implementations, each of the data networks (1408) and (1410) may consist of substantially a single networking technology (e.g., a wired Ethernet network), or may include a variety of technologies (e.g., a combination of Ethernet, WiFi, cellular (e.g., 3G, 4G, etc.), optical and WiMAX networks). In some implementations, each of the data networks (1408) and (1410) may include multiple networks. In one implementation, either or both of the data networks (1408) and (1410) may be the Internet, or may be connected to the Internet. In one implementation, either of the data networks (1408) and (1410) does not exist, or they the same network.

In various implementations, the data processing system (1412) is connected to one or both of the data networks (1408) and (1410), and possibly to additional networks not shown in FIG. 14.

Various embodiments described in this patent may be implemented using a general architecture similar to the system outlined in FIG. 14. For example, the UI discussed in connection with the embodiment shown in FIG. 2A (including sidebar (201) and results window (202)) may be displayed on any of the data processing devices (1402), (1404) and (1406). The external applications 204 associated with the embodiment shown in FIG. 2B may be running on any of the data processing devices (1402), (1404), (1406) or (1412).

### Additional Exemplary Implementations

An embodiment of the invention provides a data processing system comprising an operating system, a set of data processing modules, a first application and a second application, where the first application and the second application are capable of running on the operating system. Examples of operating systems include Microsoft Windows, Linux, Unix, mobile device operating systems (including Palm OS, Windows Mobile, Android), client computer operating systems, and any other set of instructions that enables operation of a data processing system. Examples of the first and second application include email programs (e.g., Microsoft Outlook, Google Gmail), word processors, spreadsheet programs, programs for management, editing, display and playback of digital photographs, video and other multimedia files, any other programs capable of performing any action on a data item, and any combination of the foregoing.

In one implementation, the set of data processing modules is capable of assigning at least one tag to each data item included in a first set of data items, the first set of data items corresponding to the first application. The set of data processing modules is further capable of assigning at least one tag to each data item included in a second set of data items, the second set of data items corresponding to the second application. The set of data items is also capable of identifying a group of related data items based on corresponding assigned tags, the group of related data items including at least one data item corresponding to the first application and at least one data item corresponding to the second application.

In one embodiment, the assignment of each tag is based on a set of attributes or characteristics of the corresponding data item. The characteristics of the corresponding data item may include one or more of the following: name of the data item, location of the data item within a corresponding file structure, name of a folder in which the data item is located, name of a sender of the data item, name of a recipient of the data item, date when the data item was sent, data source of the data item, meta-data corresponding to the data item, or content of the data item.

In one embodiment, each data item includes one or more of the following: an email message, a digital photograph, a webmail message, a text message, a web bookmark, a network resource, an audio file, a video file, a result of a search, an individual piece of information stored in an electronic format that is part of a larger data set, or any other electronic file that can be accessed by the data processing system.

In one embodiment, the identification of the group of related data items is made based on corresponding assigned tags, via a forced tag group, in response to a user assigning one or more characteristics of at least one of the corresponding assigned tags.

In one embodiment, the identification of the group of related data items is made automatically, by a set of modules capable of automatic data processing, via a natural tag group, based on one or more characteristics of at least one of the corresponding assigned tags. At least one of the set of modules may utilize at least one artificial intelligence algorithm, at least one fuzzy logic engine, at least one neural network, at least one rule, any other automatic data processing approach, or any combination of the foregoing. The characteristics of the assigned tags used during the automatic processing may include a relationship of at least one data item with at least one other substantially similar data item, a suggestion through connections to social tagging sites (e.g., www.delicious.com), a synonym of a word, any other logical or semantic relationships contained within the data items; or any combination of the foregoing.

An embodiment of the invention provides a data processing system capable of communicating with a remote application, the data processing system comprising a set of modules.

In one implementation, the set of modules is capable of selecting at least one data item from a plurality of data items, and assigning at least one taglet to each of the selected data items. Upon assignment of a taglet to a particular selected data item, the set of modules is capable of initiating an operation in connection with the remote application. In this embodiment of the invention, the remote application is not a process supporting an email program. Examples of remote applications contemplated by embodiments of the present invention include remote applications that run on one or more remote data processing systems and provide functionality such as the following:
photo sharing functionality, and wherein the operation includes uploading a photograph to the remote server;
Sharing data items or their tags on social networks, online bookmarking sites such as www.delicious.com and others, blogs, and other online media;
Moving data items or their tags to a remote data processing system;
Uploading data items or their tags to an order management system or other type of database;
Uploading one or more videos to YouTube and other websites or servers;
Scheduling calendar events;
sending out a Twitter of elected data item text, or a URL, or any other data
attaching one or more emails or files to information stored in a database (for example, relating external data to database data)
creating related notes to data items (e.g., launching Microsoft Notepad to create a note related to an email)
Creating maps of data items based on geographic tags associated to the data item (e.g., a photo tagged with San Francisco and Fisherman's Wharf will be mapped to that geographic location)
Digital compression of one or more data items or tags
Sharing a tag structure via email by appending tags to email subject lines
Sharing a tagged URL to social networks, wherein each social network may have a separate tag and operation associated with it; and
Any combination of the foregoing.

In one implementation, each assigned taglet is based on a set of characteristics of the corresponding data item. The characteristics of the corresponding data item may include one or more of the following: name of the data item, location of the data item within a corresponding file structure, name of a folder in which the data item is located, name of a sender of the data item, name of a recipient of the data item, date when the data item was sent, data source of the data item, meta-data corresponding to the data item, or content of the data item.

In one implementation, each data item corresponding to a taglet includes one or more of the following: an email message, a digital photograph, a webmail message, a text message, a web bookmark, a network resource, an audio file, a video file, a result of a search, an individual piece of information stored in an electronic format that is part of a larger data set, or any other electronic file that can be accessed by the data processing system.

In one implementation, the graphical user interface includes a tag view area separate from the application. The separate tag view are may be a separate window, menu bar, display box or some other substantially delineated viewable element that is displayed on the screen of the data processing system in an area substantially distinct from the windows of the application.

In one implementation, the set of data processing modules are capable of displaying a data item within the graphical user interface. The set of modules can further display at least one tag in the tag view area, where the at least one tag corresponds to the displayed data item.

In one implementation, the set of modules can further process input from a user, possibly interaction by a user with at least one of the tags displayed in the tag view area. In an alternative embodiment, the interaction of the user is with the displayed data item. In yet another embodiment, the interaction of the user is with both a data item and a tag, whether simultaneously or in any sequence. In response to such input from the user, the set of modules can further display information associated with the data item, the displayed information including data corresponding to the at least one application.

In one implementation, the displayed information further includes data obtained from a remote application. The displayed information may include (a) a phone number, an email address, address information, and any other contact information, (b) social network profile information from social networking sites, including LinkedIn, Facebook, MySpace; and (c) summary stock quote data, including charts and pricing information, from data providers (e.g., including Yahoo or Google Finance).

In one implementation, at least one of the tags displayed in the tag view area corresponds to a set of additional data items, and the displayed information includes aggregated information relating to the displayed data item and to the set of additional data items, including volume of information, number of data items tagged, and other similar data.

An embodiment of the invention provides a data processing system comprising a graphical user interface, wherein the graphical user interface includes a first tag view area and a second tag view area. Each view area may be a separate window, menu bar, display box or some other substantially delineated viewable element that is displayed on the screen of the data processing system.

In one implementation, the data processing system further comprises a set of modules, wherein the set of modules is capable of displaying within the first tag view area at least one tag assigned to a data item. The set of modules is capable of receiving input corresponding to a user interacting within the graphical user interface with the data item. In an alternative embodiment, the user interacts within the graphical interface with one or more of the tags displayed in the first tag view area. In yet another embodiment, the user interacts with both the data item and within one or more of the tags displayed in the first tag view area, either simultaneously or in any sequence.

In an implementation, in response to the input received, the set of modules is then capable of displaying at least one related tag in the second tag view area, wherein the at least one related tag corresponds to the data item.

In one implementation, the assignment of each tag is based on a set of characteristics of the corresponding data item. The characteristics may include one or more of the following: name of the data item, location of the data item within a corresponding file structure, name of a folder in which the data item is located, name of a sender of the data item, name of a recipient of the data item, date when the data item was sent, data source of the data item, meta-data corresponding to the data item, or content of the data item.

### Context-Aware Folders

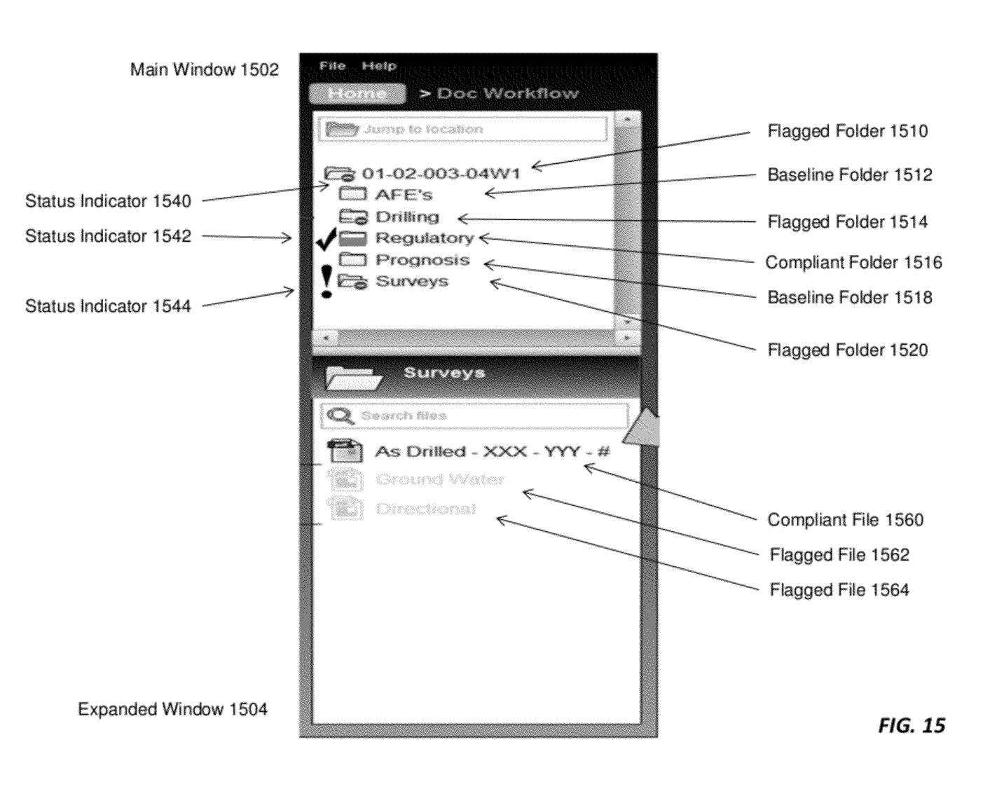

FIG. 15 shows a set of context-aware folders and associated GUI aspects, in accordance with an embodiment. In the embodiment of FIG. 15, a summary window 1502 illustrates a set of folders that are adapted to store one or more files. The summary window 1502 shows a set of flagged folders denoted flagged folders 1510, 1514, and 1520. The summary window 1502 also shows a set of baseline folders, denoted baseline folders 1512 and 1518. In various embodiments, a summary window may be denoted an “upper pane,” a “main window,” or using similar terminology.

In various embodiments, a summary window such as summary window 1502 may include any number of baseline, flagged and/or compliant folders. In various embodiments, a summary window such as summary window 1502 may include no baseline, no flagged, and/or no compliant folders, although unless all folders are hidden through a GUI action, at least one type of folder would normally be shown.

In accordance with various embodiments, a folder is denoted a “context-aware” folder (or sometimes “smart folder,” “intelligent folder,” or using analogous appropriate terminology) when the folder has the capability to automatically indicate to a user a relationship between the content of that folder and a characteristic template of that folder.

In various embodiments, a context-aware folder has a characteristic template associated with a particular characteristic file structure. The file structure and template characteristic to any particular context-aware folder may specify, for example, various attributes of files and/or folders expected to exist in that folder, including, for example, the types of files (e.g., file format, such as PDF, GIF, etc.), the names of files, the size of files (e.g., video files are expected to be at least 1 MB), the data of creation or modification of files, and so on. In general, the characteristic file structure associated with a template of a context-aware folder may include any one or more of the following template attributes:

1. the presence of a file;

2. the presence of a predetermined number of files;

3. the presence of a folder;

4. the presence of a predetermined number of folders;

5. the presence of at least one file and of at least one folder;

6. the presence of a predetermined number of files and of a predetermined number of folders;

7. the absence of a file;

8. the absence of a folder;

9. the presence or absence of a file type, including a file format;

10. the presence or absence of a file name or of a character string in a file name;

11. an expected minimum size, expected maximum size, or expected size range for one or more files and/or folders; and/or

12. the presence or absence of any content in a file (e.g., specific key words, specific text formatting or document structure, specific number of pages, minimum number of words, audio or video information, etc.).

In one embodiment, the characteristic template of a context-aware folder can be construed to be the same as the characteristic file structure of that folder. In one embodiment, the characteristic template of a context-aware can be construed to be an abstract representation of the characteristic file structure of that folder (e.g., from a GUI architectural standpoint a designer may prefer to reference the template, whereas from a software development standpoint a programmer may prefer to reference the file structure). Regardless of terminology, in various embodiments, there is a direct correlation between the characteristic template and characteristic file structure of a context-aware folder.

In various embodiments, a context-aware folder is able to determine and/or indicate a relationship between the folder's contents and the folder's characteristic template. For example, a context-aware folder may determine that it is missing one or more files, or that the size of a file is outside a particular range. In general, a context-aware folder may be adapted to determine whether the contents of the folder are compliant with any particular attribute or combination of attributes of that folder's characteristic template.

In various embodiments, if a context-aware folder determines that the contents of the folder are sufficiently compliant with its characteristic template, the folder may be identified in the GUI as a compliant folder.

In various embodiments, if a context-aware folder determines that the contents of the folder are not sufficiently compliant with its characteristic template, the folder may be identified in the GUI as a flagged folder. In some implementations, if a context-aware folder has any degree of noncompliance with the characteristic template, the folder would be identified as a flagged folder. In some implementations, if a context-aware folder has only a small degree of noncompliance with the characteristic template (e.g., the name of a file is substantially identical with the name of an expected file, although not exactly identical), the folder may be identified as a compliant folder. In general, the rules employed to classify context-aware folders may vary depending on the particular GUI, context, electronic device, user and other variables.

In various embodiments, if a context-aware folder is not activated (e.g., its characteristic template is not loaded or the template-related functionality of the folder is otherwise deactivated), the folder may be identified in the GUI as a baseline folder. Standard folders present in the GUI (i.e., folders that do not include context-aware functionality) may be shown by convention as baseline folders by default. In one embodiment, a context-aware folder for which the template-related functionality is not activated is shown with a different icon than a standard folder so that a user can easily ascertain that the respective folder is a temporarily-inactive context-aware folder.

In various embodiments, to indicate compliance or noncompliance with one or more attributes of a characteristic template, a context-aware folder may display a status indicator in the GUI. Status indicators may include graphical indicators, textual indicators, colors, or combinations of graphics, symbols, colors and/or text. In general, status indicators would be selected such that they visually convey the compliance or noncompliance status of the context-aware folder in a convenient and efficient way. For example, to indicate noncompliance with one or more attributes of a characteristic template, a context-aware folder may display a graphical indicator in the form of a “Stop” sign, red symbol sign, error sign, exclamation sign, or “X” mark, or may display a textual indicator with a short message such as “Incomplete,” “File needed,” “Wrong file,” or so on.

In various embodiments, status indicators can be adapted to indicate various degrees, types of compliance or noncompliance (e.g., the color of a folder, file or graphical indicator may vary from green for full compliance, to yellow for substantial compliance, to red for substantial or complete noncompliance).

In various embodiments, a status indicator may consist of a modified icon of a context-aware folder (e.g., a modified graphical aspect of the folder icon, or a modified color of the folder icon), or may be a discrete graphic, symbol or textual indicator that can be displayed independently of the icon of the context-aware folder. In various embodiments, a status indicator may consist of a modified text field displayed in the GUI for a context-aware folder (e.g., a color-highlighted file name or comment field shown in a GUI).

In various embodiments, the graphical image, symbol, color or text used for a context-aware flagged folder to indicate an error or noncompliance with a template may vary, but the goal of a status indicator for a flagged folder, such as status indicator 1540 shown in FIG. 15 for the flagged folder 1510, would normally be to indicate an error, to identify certain missing content, and/or to identify the need for a further action in connection with a corresponding flagged folder.

In various embodiments, a status indicator may be displayed in any suitable location in the GUI, including partially or fully superimposed over the icon of a context-aware folder, partially or fully superimposed on a text field of a context-aware folder, in proximity of the icon of a context-aware folder, in proximity of a text field of a context-aware folder, in a window, text box or other insert displayed within the GUI, in a pop-up window, pane or other element that is displayed within the GUI, in a window bar or border, or in any other area visible to a user where the status indicator can be visually correlated with the respective context-aware folder.

Various embodiments provide reporting capabilities that enable a system to generate reports summarizing the compliance status of one or more context-aware folders, and/or of one or more files stored in one or more context-aware folders. For example, a user of the system may desire to understand to what extent the files and/or folders on a data processing system are compliant with the applicable characteristic templates. Various embodiments may consequently be configured to summarize the compliance status at the folder level, at the file level, or at the system level. At the file level, for example, the system may report which specific files are not compliant, and possibly to also specify what the noncompliance is (e.g., “file sample_file_{—}1.doc is in DOC format but should be in PDF format,” or “file sample_file_{—}2.pdf should have been updated in the past three weeks but was last updated on Dec. 12, 2011,” or “file sample_file_{—}3.jpg is missing”). At the folder level, for example, the system may report to what extent specific context-aware folders are not compliant, and possibly to also specify what the noncompliance is (e.g., “folder sample_folder_{—}1 is missing three files and has two noncompliant files”). At the system level, for example, the system may report to what extent various context-aware folders are not compliant, and possibly to also specify what the noncompliance is (e.g., “five folders are not compliant,” or “three folders are missing files”).

In the embodiment of FIG. 15, status indicator 1540 comprises a graphical image superimposed partially over the default folder icon of the flagged folder 1510 and indicates a noncompliance with the corresponding folder template. In a color GUI, the status indicator 1540 may be displayed in red, or in another color that indicates the need for a remedial action.

In the embodiment of FIG. 15, three context-aware folders are identified as flagged folders 1510, 1514 and 1520 using graphical status indicators similar to status indicator 1540, which is disposed partially over the default icon of the respective folders. Flagged folder 1520 is further identified as a flagged folder using an additional graphical status indicator 1544 displayed in the form of an exclamation sign and positioned in the proximity of the icon of the flagged folder 1520. In some embodiments, only one status indicator is used for each context-aware folder to indicate noncompliance with a corresponding template. In some embodiments, more than one status indicator may be used for each context-aware folder, possibly to indicate different types of errors or noncompliance, or different types of remedial actions suggested or required.

The summary window 1502 in the embodiment of FIG. 15 also shows two baseline folders 1512 and 1518. The two baseline folders may be standard GUI folders (i.e., folders that are not context-aware), or may be context-aware folders whose template-related functionality is not currently enabled.

The summary window 1502 in the embodiment of FIG. 15 also shows a compliant folder 1516, identified by a graphical status indicator 1542 in the shape of a checkmark displayed in proximity of the icon of the compliant folder 1516.

In the embodiment of FIG. 15, the GUI also comprises a details window 1504, which shows the contents of the flagged folder 1522. In various embodiments, one or more windows, boxes or other GUI elements, such as the details window 1504, may be used to display content information for context-aware folders, such as files included in one or more folders included in a summary window and/or other information relating to such folders or files.

In various embodiments, a details window may be used to visually indicate the details of the compliance or noncompliance of a context-aware folder with the corresponding characteristic template.

In one embodiment, a details window shows the files and folders expected to be present in a context-aware folder as defined in the corresponding characteristic template. In one embodiment, any such files or folders that are missing from the respective context-aware folder are identified as “placeholder files” using a corresponding status indicator, possibly in manners similar to the ways in which folders are identified as flagged folders as discussed above. In one embodiment, a missing file or folder is displayed in a lighter font and/or with a lighter graphical icon, and is sometimes denoted a “grayed-out file” or a “ghost file,” or respectively “grayed-out folder” or a “ghost folder.” A placeholder file may also sometimes be denoted a “flagged file,” a “missing file,” or using similar terminology.

The details window 1504 shown in the embodiment of FIG. 15 shows three files that are expected to be included in the context-aware folder “Surveys” which is identified as flagged folder 1520. As shown in FIG. 15, the first file in the details window 1504 is already present in the flagged folder 1520 and otherwise satisfies any applicable requirements defined in the characteristic template of the folder 1520. Consequently, the first file is displayed with a normal font and icon and is considered a compliant file, illustrated as compliant file 1560. In one embodiment, a compliant file could be further identified with a status indicator as discussed above in connection with compliant folders.

The second and third files shown in the details window 1504 are missing, and are consequently identifies as noncompliant files, denoted as flagged files 1562 and 1564. In the embodiment of FIG. 15, these two files are displayed as grayed-out files. In one embodiment, a flagged file could be further identified with a status indicator as discussed above in connection with flagged folders.

In one embodiment, when a user drops a file or folder on a context-aware folder or in an extended window corresponding to a context-aware folder, the system automatically determines if the file or folder belongs in the respective context-aware folder, and if it is otherwise compliant with the characteristic template. If a dropped file is identified as satisfying the criteria expected for a currently flagged file, the dropped file can be automatically accepted in the flagged folder, and the status indicator of the currently flagged file can be modified to indicate that the respective file is now a compliant file.

In various embodiments, a system may take a specific action in connection with a context-aware folder. For example, when a context-aware folder that was initially denoted as a flagged folder becomes compliant with the corresponding template and is converted to a compliant folder, the system could automatically send an email message to one or more users notifying them of the change, send a text or multimedia message, upload a message to a server, cause a message to be displayed on a website page, modifying a tag of a data item, and/or activate a taglet corresponding to a data item.

In various embodiments, the comparison between the contents of a context-aware folder and the corresponding characteristic template includes at least one of the following:

1. a determination that a file or a folder is included in the characteristic template and is consequently properly stored in the context-aware folder;

2. a determination that a file or a folder is not included in the characteristic template and is consequently not properly stored in the context-aware folder; or

3. a determination that none of the files and/or folders specified in the characteristic template are present in the context-aware folder, and consequently at least one file or folder is missing from the context-aware folder.

While the discussion above of context-aware folders was focused on files and folders, that discussion can be further extended to apply to additional types of data items. In general, a context-aware folder and its characteristic template can be adapted to handle virtually any type of data item, and the classification of context-aware folders as compliant or flagged folders may be done with respect to any such data items.

In various embodiments, examples of data items that may be stored in context-aware folders, may be specified in characteristic templates, and may be used as the basis for classifying context-aware folders as compliant or flagged folders include the following:

1. an electronic file;

2. a folder;

3. an email message;

4. a digital photograph;

5. a webmail message;

6. a text message;

7. a web bookmark;

8. a network resource;

9. an audio file;

10. a video file;

11. a result of a search; or

12. a characteristic of a tag of a data item.

Examples of characteristics of data items that may be used as a basis for classifying a context-aware folder as a flagged or compliant folder include one or more of the following: name of the data item, location of the data item within a corresponding file structure, name of a folder in which the data item is located, name of a sender of the data item, name of a recipient of the data item, date when the data item was sent, data source of the data item, meta-data corresponding to the data item, content of the data item, a category to which the data item belongs, a relationship of the data item with at least one other substantially similar data item, a suggestion received from a different remote data processing system, a synonym of a word; or a logical or semantic relationship associated with a data item.

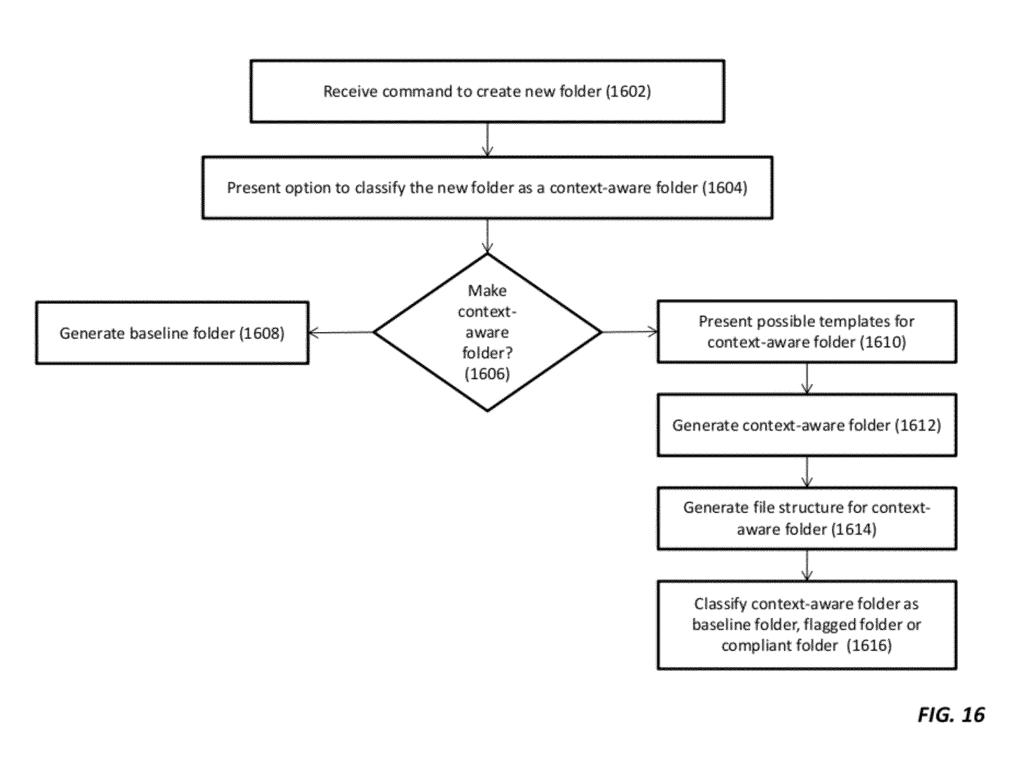

FIG. 16 shows a flowchart illustrating a process for creating a context-aware folder in accordance with an embodiment. The method illustrated in the embodiment of FIG. 16 may be implemented in an operating system running on an electronic device, or could be implemented in a particular application running on an operating system.

In the embodiment of FIG. 16, a command is received at step 1602 to create a new folder. This command may be received automatically when a user attempts to create a new baseline folder in an operating system or in an application, or may be a dedicated command issued by a user who is specifically attempting to create a context-aware folder.

At step 1604, the system presents to the user an option to classify the new folder as a context-aware folder. This option may be presented actively (e.g., a pop-up message requesting the user to specify whether the new folder is to be classified as a context-aware folder), or may be presented passively (e.g., a checkbox that the user may check to make the new folder a context-aware folder). In one embodiment, a new folder is automatically classified by the system as a context-aware folder.

At step 1606, the system determines if the new folder should indeed be made a context-aware folder. In one embodiment, this decision is made based on input received from the user at step 1604. In one embodiment, this decision is made automatically.

If the decision to make the new folder a context-aware folder is negative, the system defines the new folder as a baseline folder (e.g., a standard operating system folder) at step 1606.

If the decision to make the new folder a context-aware folder is affirmative, the system presents the user at step 1610 with one or more possible templates that could be used to define the file structure for the context-aware folder. The one or more templates may be presented as part of a drop-down menu, list of items, set of icons, or in any other suitable form given the respective GUI context.

In one embodiment, the system does not present the user with any explicit option at step 1610, and instead allocates a predetermined characteristic template for the context-aware folder.

At step 1612, the system generates a context-aware folder using the characteristic template defined at step 1610.

At step 1614, the system generates a file structure for the context aware-folder based on the characteristic template defined at step 1610. In various embodiments, the steps 1610, 1612 and/or 1614 may be performed as separate steps or as combined steps.

At step 1616, the system may automatically classify the newly created context-aware folder as a baseline folder if the template is not activated, as a flagged folder if one or more of the conditions specified in the template are not met (e.g., if the template requires the presence of a file and the newly formed folder does not include that file yet), or as a compliant folder (e.g., if the template does not specify any requirements for the new context-aware folder).

In various embodiments, to classify a context-aware folder as a flagged folder or as a compliant folder, a system may employ a rule-based approach. For example, a system may check the file structure and other content present inside a context-aware folder against one or more attributes of the corresponding characteristic template. The rules applicable to different context-aware folders may differ even if the attributes of their characteristic templates are the same (e.g., for one context-aware folder the applicable rules may require all files to have a particular size and no expiration limitations, whereas for a different context aware folder the applicable rules may require that one or more files are updated within a particular timeframe but without imposing any limitations on file sizes).

Examples of rules that could be applied to context-aware folders include expiration dates (e.g., one or more files must be updated at a particular time), content types (e.g., a particular file must be in a PDF or ASCII format), and any other compliance requirement that can be defined based on attributes of files, folders, tags, or other content of context-aware folders.

In one embodiment, the system may act automatically to remedy problems identified in a flagged folder. For example, the system may be configured to recognize a file that is stored or dropped in a context-aware folder as having the appropriate content but the incorrect format, and the system may automatically act to remedy the deficiency (e.g., the system could automatically correct a document stored in a Microsoft Word or ASCII format to a PDF format).

In various embodiments, to classify a context-aware folder as a flagged folder or as a compliant folder, a system may employ a fuzzy logic engine. This approach may become more suitable as the content, number of files, number of folders, and/or number of subfolders in a context-aware folder increase, and as the rules applicable to determine whether the respective folder is a compliant folder become more complex. For example, a system may use numerical ranges to quantify various template attributes and/or probability-based estimations regarding compliance with particular template attributes to determine a total compliance score for the respective context-aware folder.

In various embodiments, to generate the basis on which a system classifies a context-aware folder as a flagged folder or as a compliant folder, a system may employ a neural network engine or another self-learning approach. For example, a system may be trained to learn under what circumstances a context-aware folder should be classified as compliant, flagged or baseline, and to what degrees compliance with a characteristic template should be construed to exist. A self-learning system may be programmed to continue to observe user input and corrective actions taken by users in connection with context-aware folders over time, and could continue to refine its behavior.

In various embodiments, context-aware folders or similar folder management processes may be implemented in virtually any GUI-based operating system running on a data processing system, such as Microsoft Windows, Linux, Unix, mobile device operating systems (including Palm OS, Windows Mobile, Android), client computer operating systems, or in any other set of instructions that enables operation of a data processing system.

### Ad-Hoc Electronic File Attribute Definition

In various embodiments, one or more attributes of a data item can be automatically defined based on a preexisting template file or characteristic template.

Examples of attributes of a file or other data item that can be automatically defined in accordance with various embodiments include the name of a file or other data item, the author of a file or other data item, the creation date or modification date of a file or other data item (or any other date and/or time information associated with the file or data item), the content of a file or other data item (e.g., any portion of the content of a file or other data item such as a document structure, a title, an outline format, a field in a file, or any other text, graphical, audio or video information included in the file or other data item), a tag of a file or other data item, a characteristic of a tag of a file or data item, and any other information relating to a file or other data item.

In various embodiments, defining the name of a file or another attribute of a file automatically may help a user save time and/or avoid typing when storing a file or other data item in a folder. This may be particularly helpful for a GUI-based data processing system, such as a smartphone or electronic tablet with a touch-screen GUI interface, where typing may be more inconvenient for a user. On a traditional data processing system where a physical keyboard is available, such as a desktop or laptop computer, defining the name of a file or another attribute of a file automatically may allow a user to avoid having to manually change the name of a the file using the operating system naming functionality, or to avoid having to manually set preferences or other attributes of the file using the file management tools available on the operating system.

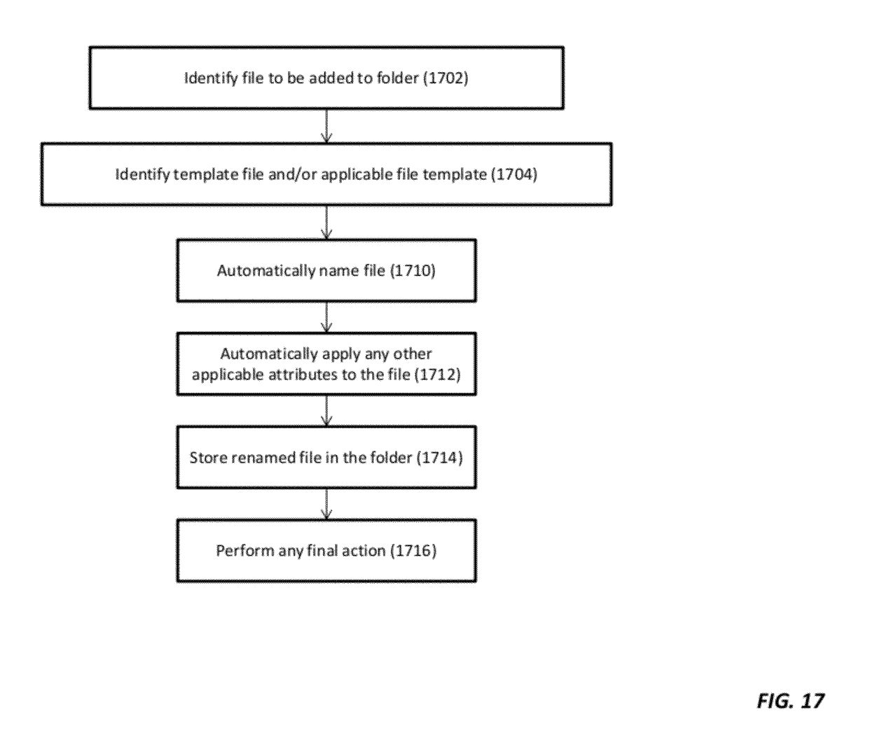

FIG. 17 shows a flowchart illustrating a process for automatically defining the name or other attributes of a file, in accordance with an embodiment. The method illustrated in the embodiment of FIG. 17 may be implemented in an operating system running on an electronic device, or could be implemented in a particular application running on an operating system. The method illustrated in the embodiment of FIG. 17 may be used for context-aware folders and/or for other folders.

In the embodiment of FIG. 17, a file to be added to a folder is identifies at step 1602. This file may be identified automatically when a user attempts to drop a file in a folder (e.g., the file that the user is attempting to drop in a folder is automatically selected by the system as the file whose name or other attribute is to be automatically modified), or may be manually identified by a user (e.g., using a checkbox selection method for selecting files provided by an operating system or by an application, or selecting a file from a drop-down menu).

At step 1704, the system identifies the template file to be used as a basis for automatically defining the name or other attribute of the file being added to the folder. In one embodiment, the system identifies the template file in response to the user dropping the file being added to the folder on top of that particular template file. In one embodiment, the system identifies a template file in response to a user manually selecting the template file and indicating that it should be used as the template for the file being added.

In various embodiments, to automatically identify a file to be added to a folder, a system may provide to a user visual or auditory feedback when the user drags a file over the icon of an existing file or folder displayed in the GUI of a data processing system. For example, in various embodiments, when a user drags a file over the icon of a pre-existing file displayed in the GUI, such as a placeholder file displayed in a folder, the GUI may display a hint, text box, window, or pop-up window, or may change the color or otherwise alter the icon of the pre-existing file or of the new file to indicate to the user that the pre-existing file can be used as a template for the new file that is being added. Analogously, in various embodiments, when a user drags a file over the icon of a pre-existing file displayed in the GUI, the user may receive an auditory signal (e.g., a beep, tone, or verbal message) to indicate that the pre-existing file can be used as a template for the new file that is being added to the folder.

In various embodiments, the GUI may use specific methods to display to a user pre-existing electronic template files that can be used as a template for automatically defining names or other attributes of new files being added to a folder. For example, electronic template files that can be used as a template may be shown in the GUI with specific graphical attributes (e.g., a particular color or icon), or may be separated from other files by particular graphical features shown in the GUI (e.g., lines delineating template files from other files, 3D features showing template files as raised or lowered within a file list, etc.).

In various embodiments, an electronic template file may be identified in a GUI using one or more of the following:
altering the icon of the template file;
superimposing a graphical or textual indicator at least partially over the icon of the template file;
displaying a graphical or textual indicator in the proximity of the icon of the template file;
displaying a text message in the GUI;
sending an email message;
sending a text or multimedia message;
uploading a message to a server;
causing a message to be displayed on a remote website page;
modifying a tag of the template file; or
activating a taglet corresponding to the template file.

In one embodiment, instead of identifying a template file, the system may identify a characteristic template of a file or of a folder to be used as a basis for automatically defining the name or other attribute of the file being added to the folder. In one embodiment, in addition to identifying a template file, the system may also identify a characteristic template of a file or of a folder to be further used as a basis for automatically defining the name or other attribute of the file being added to the folder (e.g., the name of the file may be defined based on the template file, while other attributes of the file may be defined based on the characteristic template).

At step 1710, the system may automatically name the file being added based on the template file and/or the characteristic template. For example, if a user drops a file on top of a preexisting template file named “file_{—}1.doc,” the system may automatically name the new file “file_{—}2.doc” or “file_{—}1_added.doc”.

At step 1712, the system may automatically apply one or more attributes to the file being added based on the template file and/or the characteristic template. For example, if a user drops a file on top of a preexisting template file, the system may automatically apply to the newly added file the author name from the template file, or may introduce inside the newly added file certain textual, graphical, auditory and/or video content from the characteristic template or from a template or other reference file.

In various embodiments, either step 1710 or step 1712 may be skipped. In various embodiments, the steps 1710 and 1712 may be performed together, as a single step.

At step 1714, the newly added file is stored in the respective folder. In various embodiments, the newly added file may be copied to one or more additional folders, or may be transmitted remotely to a different data processing system or memory storage.

At step 1716, the system may perform one or more additional functions. In one embodiment, the system may automatically send an email message to one or more users notifying them of the newly added file, send a text or multimedia message, upload a message to a server, cause a message to be displayed on a website page, modifying a tag of a data item, and/or activate a taglet corresponding to that file or to another data item.

In various embodiments, the methods for automatically defining names or other attributes of files or data items described above may also be adapted to apply in a similar manner to automatically define names or other attributes of folders, including context-aware folders and baseline folders.

In various embodiments, methods for automatically defining names or other attributes of files, data items and/or folders may be implemented in virtually any GUI-based operating system running on a data processing system, such as Microsoft Windows, Linux, Unix, mobile device operating systems (including Palm OS, Windows Mobile, Android), client computer operating systems, or in any other set of instructions that enables operation of a data processing system.

This specification describes in detail various embodiments and implementations of the present invention, and the present invention is open to additional embodiments and implementations, further modifications, and alternative constructions. There is no intention in this patent to limit the invention to the particular embodiments and implementations disclosed; on the contrary, this patent is intended to cover all modifications, equivalents and alternative embodiments and implementations that fall within the scope of the claims.

What is claimed is:

1. A data processing system comprising a set of data processing modules, the set of data processing modules including at least one processor and at least one memory medium, the data processing system adapted to:
display a graphical user interface (GUI), the GUI including a folder;
identify an electronic file to be added to the folder;
identify at least one of an electronic template file and a characteristic template; and
based on the at least one of an electronic template file and a characteristic template, automatically define at least a portion of at least one attribute of the electronic file.

2. The data processing system of claim 1, wherein the attribute of the electronic file is at least one of the following:
the name of the electronic file;
the author of a electronic file;
the creation date of the electronic file;
the modification date of the electronic file;
content included in the electronic file;
a tag of the electronic file; or
a characteristic of a tag of the electronic file.

3. The data processing system of claim 1, wherein the folder is a context-aware folder.

4. The data processing system of claim 1, wherein the electronic template file is a placeholder file.

5. The data processing system of claim 1, wherein the characteristic template corresponds to the electronic template file and/or to the folder.

6. The data processing system of claim 1, wherein the electronic template file is displayed in the GUI using at least one of the following:
altering the icon of the template file;
superimposing a graphical or textual indicator at least partially over the icon of the template file;
displaying a graphical or textual indicator in the proximity of the icon of the template file;
displaying a text message in the GUI;
sending an email message;
sending a text or multimedia message;
uploading a message to a server;
causing a message to be displayed on a remote website page;
modifying a tag of the template file; or
activating a taglet corresponding to the template file.

7. The date processing system of claim 1, wherein the automatic definition of at least a portion of at least one attribute of the electronic file includes defining at least a portion of the name of the electronic file based on the name of the electronic template file.

8. The data processing system of claim 1, wherein the data processing system is a desktop computer, laptop, netbook, electronic tablet, electronic notebook, ultra mobile personal computer, client computing device, server computer, server system, cloud computing system, remote computer, mobile telephone, smartphone, personal digital assistant, or personal digital organizer.

9. A computer implemented method comprising:
displaying a graphical user interface (GUI), the GUI including a folder;
identifying a data item to be added to the folder;
identifying an electronic template file; and
based on the electronic template file, automatically defining at least a portion of at least one attribute of the data item.

10. The data processing system of claim 9, wherein the attribute of the data item is at least one of the following:
the name of the data item;
the author of the data item;
the creation date of the data item;
the modification date of the data item;
content included in the data item;
a tag of the data item; or
a characteristic of a tag of the data item.

11. The data processing system of claim 9, wherein the folder is a context-aware folder.

12. The data processing system of claim 9, wherein the electronic template file is a placeholder file.

13. The data processing system of claim 9, wherein the automatic definition of at least a portion of at least one attribute of the data item is further based on a characteristic template.

14. The data processing system of claim 9, wherein the electronic template file is displayed in the GUI using at least one of the following:
altering the icon of the template file;
superimposing a graphical or textual indicator at least partially over the icon of the template file;
displaying a graphical or textual indicator in the proximity of the icon of the template file;
displaying a text message in the GUI;
sending an email message;
sending a text or multimedia message;
uploading a message to a server;
causing a message to be displayed on a remote website page;
modifying a tag of the template file; or
activating a taglet corresponding to the template file.

15. The date processing system of claim 9, wherein the automatic definition of at least a portion of at least one attribute of the data item includes defining at least a portion of the name of the data item based on the name of the electronic template file.

16. The method of claim 9, wherein the data item is one of the following:
an electronic file;
a folder;
an email message;
a digital photograph;
a webmail message;
a text message;
a web bookmark;
a network resource;
an audio file;
a video file; or
a result of a search.

17. The data processing system of claim 9, wherein the method is performed using an operating system running on a desktop computer, laptop, netbook, electronic tablet, electronic notebook, ultra mobile personal computer, client computing device, server computer, server system, cloud computing system, remote computer, mobile telephone, smartphone, personal digital assistant, or personal digital organizer.

18. A memory medium comprising computer executable program code, the program code comprising at least one data processing module adapted to:
display a graphical user interface (GUI), the GUI including a folder;
identify a data item to be added to the folder;
identify at least one of an electronic template file and a characteristic template; and
based on the at least one of an electronic template file and a characteristic template, automatically define at least a portion of at least one attribute of the data item.
